(19) United States
(12) Patent Application Publication
(10) Pub. No.: US 2022/0308974 A1
(43) Pub. Date: Sep. 29, 2022

(54) DYNAMIC THRESHOLDS TO IDENTIFY SUCCESSIVE ALERTS

(71) Applicant: SparkCognition, Inc., Austin, TX (US)

(72) Inventors: Shreya Gupta, Austin, TX (US); Kevin Gullikson, Austin, TX (US)

(21) Appl. No.: 17/654,191

(22) Filed: Mar. 9, 2022

Related U.S. Application Data
(60) Provisional application No. 63/166,529, filed on Mar. 26, 2021.

(51) Int. Cl. G06F 11/32; G06F 11/34

(52) U.S. Cl. CPC G06F 11/321; G06F 11/328; G06F 11/3452; G06F 2201/81

(57) ABSTRACT

A method of identifying successive alerts associated with a detected deviation from an operational state of a device includes receiving feature data corresponding to an alert indication and including time series data for multiple sensor devices associated with the device. The method includes determining, based on a first portion of the feature data, first feature importance data of a first alert associated with the first portion of the feature data and determining a first alert threshold corresponding to the first alert. The method includes determining, based on a second portion of the feature data that is subsequent to the first portion, a metric corresponding to second feature importance data of the second portion. The method includes comparing the metric to the first alert threshold to determine whether the second portion corresponds to the first alert or to a second alert that is distinct from the first alert.

### CROSS-REFERENCE TO RELATED APPLICATION

The present application claims priority from U.S. Provisional Application No. 63/166,529 filed Mar. 26, 2021, entitled “DYNAMIC THRESHOLDS TO IDENTIFY SUCCESSIVE ALERTS,” which is incorporated by reference herein in its entirety.

### FIELD

The present disclosure is generally related to identifying distinct alerts that occur successively, such as during an anomalous behavior of a device.

### BACKGROUND

Equipment, such as machinery or other devices, is commonly monitored via multiple sensors that generate sensor data indicative of operation of the equipment. An anomalous operating state of the equipment may be detected via analysis of the sensor data and an alert generated to indicate that anomalous operation has been detected. The alert and the data associated with generating the alert can be provided to a subject matter expert (SME) that attempts to diagnose the factors responsible for the anomalous operation. Accurate and prompt diagnosis of such factors can guide effective remedial actions and result in significant cost savings for repair, replacement, labor, and equipment downtime, as compared to an incorrect diagnosis, a delayed diagnosis, or both.

Historical alert data may be accessed by the SME and compared to the present alert to guide the diagnosis and reduce troubleshooting time. For example, the SME may examine historical alert data to identify specific sets of sensor data associated with the historical alerts that have similar characteristics as the sensor data associated with the present alert. To illustrate, an SME examining an alert related to abnormal vibration and rotational speed measurements of a wind turbine may identify a previously diagnosed historical alert associated with similar values of vibration and rotational speed. The SME may use information, referred to as a “label,” associated with the diagnosed historical alert (e.g., a category or classification of the historical alert, a description or characterization of underlying conditions responsible for the historical alert, remedial actions taken responsive to the historical alert, etc.) to guide the diagnosis and determine remedial action for the present alert.

However, multiple successive and distinct anomalous operating states of the equipment may occur without the equipment returning to its normal operating state. For example, an initial set of factors (e.g., a power spike) may be responsible for a first type of anomalous behavior (e.g., excessive rotational speed) of the equipment, and an alert is generated indicating deviation from normal behavior. While the alert is ongoing, the equipment may transition from the first type of anomalous behavior to a second type of anomalous behavior (e.g., abnormal vibration) that is caused by a second set of factors (e.g., a damaged bearing).

In some circumstances, analysis of sensor data corresponding to the alert may lead to diagnosis of the initial set of factors (e.g., the power spike) but fail to diagnose the second set of factors (e.g., the damaged bearing), or vice-versa, resulting in incomplete diagnosis. In other circumstances, misdiagnosis may result. For example, when values of each sensor's data are time-averaged across both periods of anomalous behavior during the alert period, the resulting average values may be indicative of neither the initial set of factors nor the second set of factors and may instead indicate a third, unrelated set of factors. Incomplete diagnosis and misdiagnosis can lead to ineffective or incomplete remedial actions and can result in significant additional cost, potentially including damage to equipment that is brought back into operation without resolving all responsible factors (e.g., by diagnosing the power spike but failing to diagnose the damaged bearing).

### SUMMARY

In some aspects, a method of identifying successive alerts associated with a detected deviation from an operational state of a device includes receiving, at a processor, feature data including time series data for multiple sensor devices associated with the device. The feature data corresponds to an alert indication. The term “feature” is used herein to indicate a source of data indicative of operation of a device. For example, each of the multiple sensor devices measuring the asset's performance may be referred to as a feature, and each set of time series data (e.g., raw sensor data) from the multiple sensor devices may be referred to as “feature data.” Additionally, or alternatively, a “feature” may represent a stream of data (e.g., “feature data”) that is derived or inferred from one or more sets of raw sensor data, such as frequency transform data, moving average data, or results of computations preformed on multiple sets of raw sensor data (e.g., feature data of a “power” feature may be computed based on raw sensor data of electrical current and voltage measurements), one or more sets or subsets of other feature data, or a combination thereof, as illustrative, non-limiting examples.

The method includes determining, at the processor and based on a first portion of the feature data, first feature importance data of a first alert associated with the first portion of the feature data. As used herein, “feature importance data” refers to one or more values indicating a relative or absolute importance of each of the features to generation of the alert. The method includes determining, at the processor and based on the first portion of the feature data, a first alert threshold corresponding to the first alert. The method also includes determining, at the processor and based on a second portion of the feature data, a metric corresponding to second feature importance data of the second portion. The second portion is subsequent to the first portion in a time sequence of the feature data. The method further includes comparing, at the processor, the metric to the first alert threshold to determine whether the second portion corresponds to the first alert or to a second alert that is distinct from the first alert.

In some aspects, a system to identify successive alerts associated with a detected deviation from an operational state of a device includes a memory configured to store instructions and one or more processors coupled to the memory. The one or more processors are configured to execute the instructions to receive feature data including time series data for multiple sensor devices associated with the device. The feature data corresponds to an alert indication. The one or more processors are configured to execute the instructions to determine, based on a first portion of the feature data, first feature importance data of a first alert associated with the first portion of the feature data. The one or more processors are configured to execute the instructions to determine, based on the first portion of the feature data, a first alert threshold corresponding to the first alert. The one or more processors are also configured to execute the instructions to determine, based on a second portion of the feature data, a metric corresponding to second feature importance data of the second portion. The second portion is subsequent to the first portion in a time sequence of the feature data. The one or more processors are further configured to execute the instructions to determine, based on a comparison of the metric to the first alert threshold, whether the second portion corresponds to the first alert or to a second alert that is distinct from the first alert.

In some aspects, a computer-readable storage device stores instructions. The instructions, when executed by one or more processors, cause the one or more processors to receive feature data including time series data for multiple sensor devices associated with a device and to receive an alert indicator for an alert associated with a detected deviation from an operational state of the device. The instructions cause the one or more processors to receive feature data including time series data for multiple sensor devices associated with a device. The feature data corresponds to an alert indication. The instructions cause the one or more processors to determine, based on a first portion of the feature data, first feature importance data of a first alert associated with the first portion of the feature data. The instructions cause the one or more processors to determine, based on the first portion of the feature data, a first alert threshold corresponding to the first alert. The instructions also cause the one or more processors to determine, based on a second portion of the feature data, a metric corresponding to second feature importance data of the second portion. The second portion is subsequent to the first portion in a time sequence of the feature data. The instructions further cause the one or more processors to determine, based on a comparison of the metric to the first alert threshold, whether the second portion corresponds to the first alert or to a second alert that is distinct from the first alert.

### BRIEF DESCRIPTION OF THE DRAWINGS

FIG. 1 illustrates a block diagram of a system configured to use dynamic thresholds to identify successive alerts associated with a detected deviation from an operational state of a device, in accordance with some examples of the present disclosure.

FIG. 2 illustrates a flow chart corresponding to an example of operations that may be performed in the system of FIG. 1, according to a particular implementation.

FIG. 3 illustrates a flow chart corresponding to an example of operations that may be performed in the system of FIG. 1, according to a particular implementation.

FIG. 4 illustrates a flow chart and diagrams corresponding to operations that may be performed in the system of FIG. 1 to identify a historical alert that is similar to a detected alert, according to a particular implementation.

FIG. 5 illustrates a flow chart and diagrams corresponding to operations that may be performed in the system of FIG. 1 to determine alert similarity according to a particular implementation.

FIG. 6 illustrates a flow chart and diagrams corresponding to operations that may be performed in the system of FIG. 1 to determine alert similarity according to another particular implementation.

FIG. 7 is a flow chart of an example of a method of identifying successive alerts associated with a detected deviation from an operational state of a device.

FIG. 8 is a depiction of a first example of a graphical user interface that may be generated by the system of FIG. 1 in accordance with some examples of the present disclosure.

FIG. 9 is a depiction of a second example of a graphical user interface that may be generated by the system of FIG. 1 in accordance with some examples of the present disclosure.

### DETAILED DESCRIPTION

Systems and methods are described that enable identification of successive alerts associated with a detected deviation from an operational state of equipment. Because multiple successive and distinct anomalous operating states of the equipment may occur during an alert without the equipment returning to its normal operating state, analysis of sensor data corresponding to the alert may lead to diagnosis of one set of factors responsible for one of the anomalous operating states but fail to diagnose a second set of factors responsible for another one of the anomalous operating states, resulting in incomplete diagnosis. In other circumstances, misdiagnosis may result, such as when values of the sensor data are time-averaged across multiple distinct anomalous operating states of the equipment, and the resulting average values may be indicative of neither the initial set of factors nor the second set of factors and may instead indicate a third, unrelated set of factors. Incomplete diagnosis and misdiagnosis can lead to ineffective or incomplete remedial actions and can result in significant additional cost, potentially including damage to equipment that is brought back into operation without resolving all responsible factors associated with the multiple successive anomalous operating states of the equipment that occur during the alert.

The systems and methods described herein address such difficulties by use of dynamic thresholds to determine when one alert condition has ended and a next alert condition has commenced during a single alert period. Each successive alert that occurs during a period of anomalous behavior can be characterized based on that alert's feature importance values (e.g., values indicating how important each feature is to the generation of that alert), and a threshold value may be determined and updated as that alert is ongoing. The threshold value indicates a threshold amount that the feature importance values for a later-received set of sensor data can deviate from the current alert's feature importance value and still be characterized as belonging to the same alert, or whether the set of sensor data belonging to a new alert that is distinct from the current alert.

Thus, the described systems and methods enable detection of multiple successive and distinct alerts that may occur during a single period of anomalous operation of the equipment. As a result, occurrences of incomplete diagnosis and misdiagnosis for a period of anomalous behavior of the equipment can be reduced or eliminated, with corresponding reductions of additional cost and potential damage that may be caused by bringing equipment back online prematurely (e.g., after performing remedial actions that fail to fully address all factors contributing to the period of anomalous behavior.

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

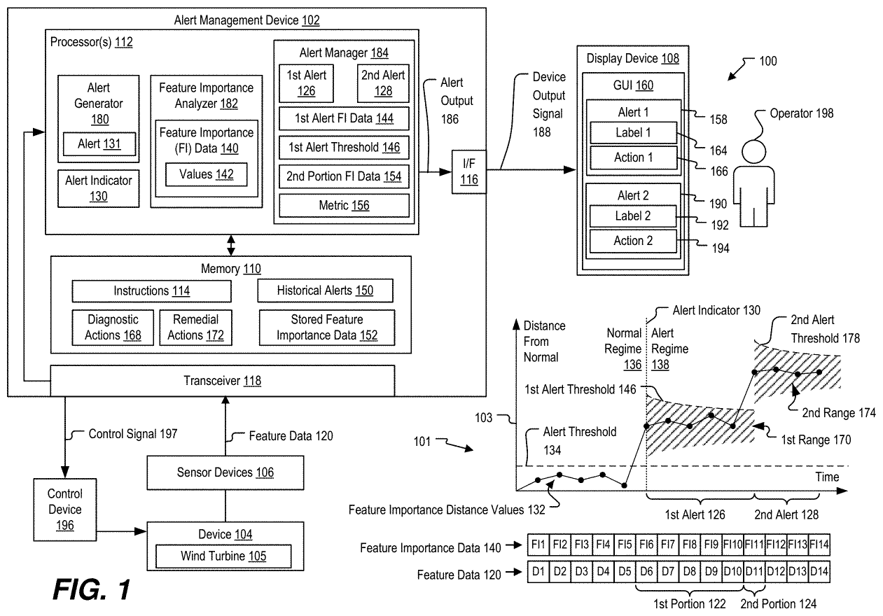

FIG. 1 depicts a system 100 configured to use dynamic thresholds to identify successive alerts associated with a detected deviation from an operational state of a device 104, such as a wind turbine 105. The system 100 includes an alert management device 102 that is coupled to sensor devices 106 that monitor operation of the device 104. The alert management device 102 is also coupled to a control device 196. A display device 108 is coupled to the alert management device 102 and is configured to provide data indicative of detected alerts to an operator 198, such as an SME.

The alert management device 102 includes a memory 110 coupled to one or more processors 112. The one or more processors 112 are further coupled to a transceiver 118 and to a display interface (I/F) 116. The transceiver 118 is configured to receive feature data 120 from the one or more sensor devices 106 and to provide the feature data 120 to the one or more processors 112 for further processing. In an example, the transceiver 118 includes a bus interface, a wireline network interface, a wireless network interface, or one or more other interfaces or circuits configured to receive the feature data 120 via wireless transmission, via wireline transmission, or any combination thereof. The transceiver 118 is further configured to send a control signal 197 to the control device 196, as explained further below.

In some implementations, the memory 110 includes volatile memory devices, non-volatile memory devices, or both, such as one or more hard drives, solid-state storage devices (e.g., flash memory, magnetic memory, or phase change memory), a random access memory (RAM), a read-only memory (ROM), one or more other types of storage devices, or any combination thereof. The memory 110 stores data and instructions 114 (e.g., computer code) that are executable by the one or more processors 112. For example, the instructions 114 are executable by the one or more processors 112 to initiate, perform, or control various operations of the alert management device 102.

As illustrated, the memory 110 includes the instructions 114, an indication of one or more diagnostic actions 168, an indication of one or more remedial actions 172, and stored feature importance data 152 for historical alerts 150. As used herein, “historical alerts” are alerts that have previously been detected and recorded, such as stored in the memory 110 for later access by the one or more processors 112. In some implementations, at least one of the historical alerts 150 corresponds to a previous alert for the device 104. For example, the historical alerts 150 include a history of alerts for the particular device 104. In some implementations in which the alert management device 102 manages alerts for multiple assets, such as the device 104 and one or more other devices, the historical alerts 150 also include a history of alerts for the one or more other devices. The instructions 114 are executable by the one or more processors 112 to perform the operations described in conjunction with the one or more processors 112.

The one or more processors 112 include one or more single-core or multi-core processing units, one or more digital signal processors (DSPs), one or more graphics processing units (GPUs), or any combination thereof. The one or more processors 112 are configured to access data and instructions from the memory 110 and to perform various operations associated with using dynamic thresholds to identify successive alerts, as described further herein.

The one or more processors 112 include an alert generator 180, a feature importance analyzer 182, and an alert manager 184. The alert generator 180 is configured to receive the feature data 120 and to generate the alert 131 responsive to detecting anomalous behavior of one or more features of the feature data 120. In an illustrative example, the alert generator 180 includes one or more models configured to perform comparisons of the feature data 120 to short-term or long-term historical norms, to one or more thresholds, or a combination thereof, and to send generate an alert indicator 130 indicating the alert 131 in response to detecting deviation from the operational state of the device 104.

The feature importance analyzer 182 is configured to receive the feature data 120 including time series data for multiple sensor devices 106 associated with the device 104 and to receive the alert indicator 130 for the alert 131. The time series data corresponds to multiple features for multiple time intervals. In an illustrative example, each feature of the feature data 120 corresponds to the time series data for a corresponding sensor device of the multiple sensor devices 106. The feature importance analyzer 182 is configured to process portions of the feature data 120 associated with the alert indicator 130 to generate feature importance data 140 for sets of the feature data 120 during the alert 131.

The feature importance data 140 includes values 142 indicating relative importance of data from each of the sensor devices 106 to generation of the alert 131. In some implementations, the feature importance data 140 for each feature may be generated using the corresponding normal (e.g., mean value and deviation) for that feature, such as by using Quartile Feature Importance. In other implementations, the feature importance data 140 may be generated using another technique, such as kernel density estimation (KDE) feature importance or a random forest, as non-limiting examples.

In a first illustrative, non-limiting example of determining the feature importance data 140 using quartiles, a machine learning model is trained to identify 101 percentiles (P0 through P100) of training data for each of the sensor devices 106, where percentile 0 for a particular sensor device is the minimum value from that sensor device in the training data, percentile 100 is the maximum value from that sensor device in the training data, percentile 50 is the median value from that sensor device in the training data, etc. To illustrate, the training data can be a portion of the feature data 120 from a non-alert period (e.g., normal operation) after a most recent system reset or repair. After training, a sensor value ‘X’ is received in the feature data 120. The feature importance score for that sensor device is calculated as the sum: abs(X−P_closest) +abs(X-P_next-closest) + . . . + abs(X−P_kth-closest), where abs( ) indicates an absolute value operator, and where k is a tunable parameter. This calculation may be repeated for all received sensor values to determine a feature importance score for all of the sensor devices.

In a second illustrative, non-limiting example of determining the feature importance data 140 using KDE, a machine learning model is trained to fit a gaussian kernel density estimate (KDE) to the training distribution (e.g., a portion of the feature data 120 from a non-alert period (e.g., normal operation) after a most recent system reset or repair) to obtain an empirical measure of the probability distribution P of values for each of the sensor devices. After training, a sensor value ‘X’ is received in the feature data 120. The feature importance score for that sensor device is calculated as 1−P(X). This calculation may be repeated for all received sensor values to determine a feature importance score for all of the sensor devices.

In a third illustrative, non-limiting example of determining the feature importance data 140 using a random forest, each tree in the random forest consists of a set of nodes with decisions based on feature values, such as “feature Y <100”. During training, the proportion of points reaching that node is determined, and a determination is made as to how much it decreases the impurity (e.g., if before the node there are 50/50 samples in class A vs. B, and after splitting, samples with Y <100 are all class A while samples with Y >100 are all class B, then there is a 100% decrease in impurity). The tree can calculate feature importance based on how often a given feature is involved in a node and how often that node is reached. The random forest calculates feature importance values as the average value for each of the individual trees.

The alert manager 184 is configured to dynamically generate alerts and thresholds for the alerts. The threshold for an alert enables the alert manager 184 to identify whether each successive set of feature data received during an alert is a continuation of the current alert or is sufficiently different from the current alert to be labelled as a new alert.

To illustrate, the alert manager 184 is configured to determine, based on a first portion of the feature data 120, feature importance data of a first alert that is associated with the first portion of the feature data 120. For example, as explained below with reference to a graph 103, when a portion of the feature data 120 causes the alert generator 180 to first trigger the alert 131, the alert manager 184 generates a first alert 126 and initializes first alert feature importance data 144 (“1st Alert FI Data”) based on the feature importance data associated with the portion of the feature data 120 that triggered the alert 131. The alert manager 184 is also configured to determine, based on the first portion of the feature data, a first alert threshold 146 corresponding to the first alert 126.

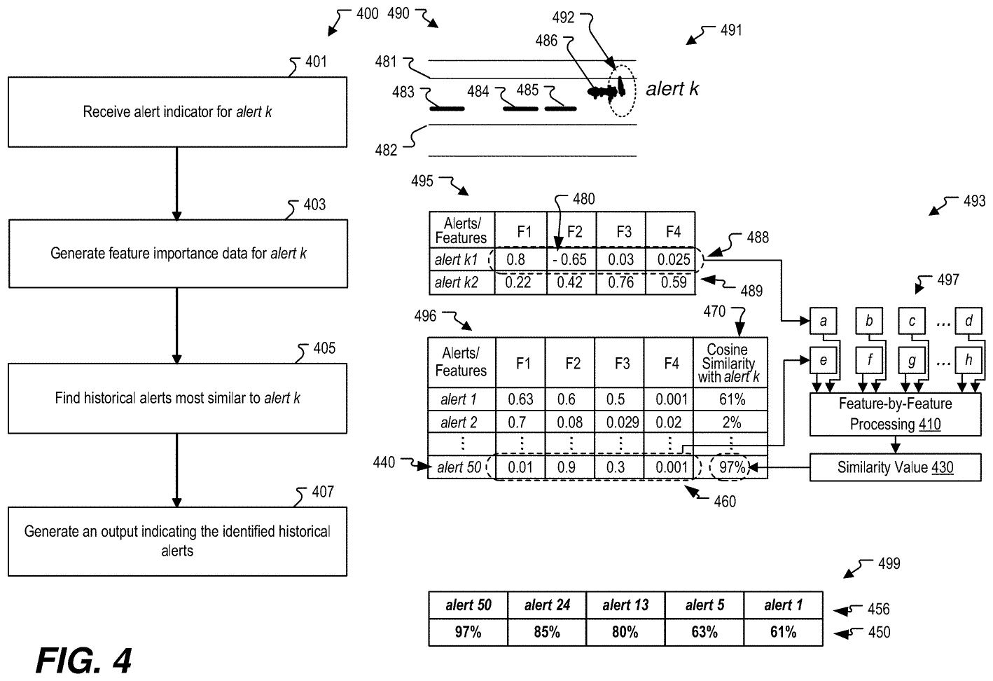

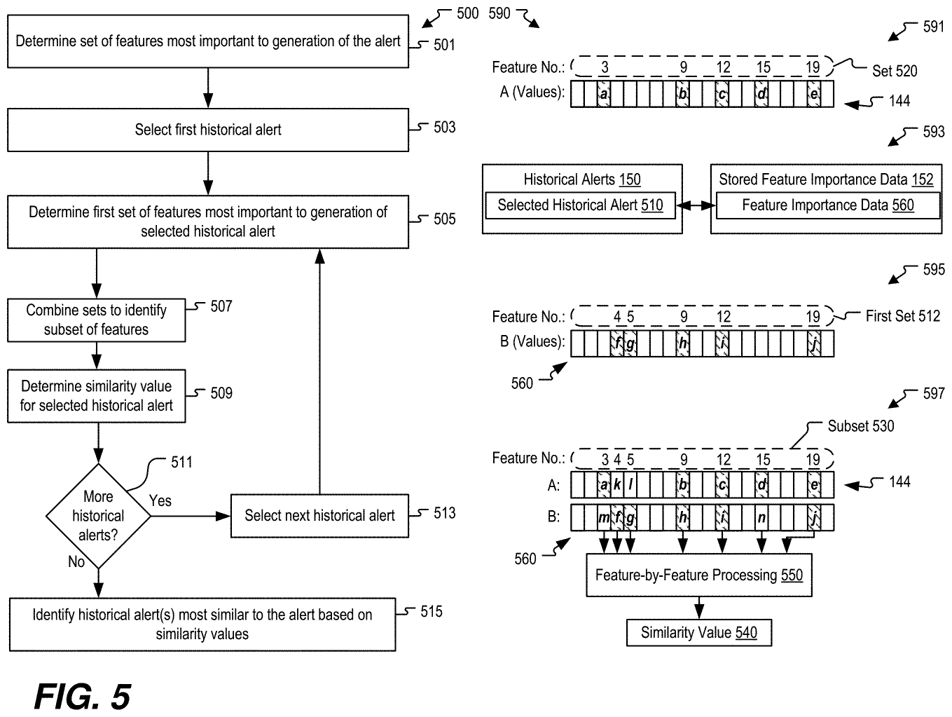

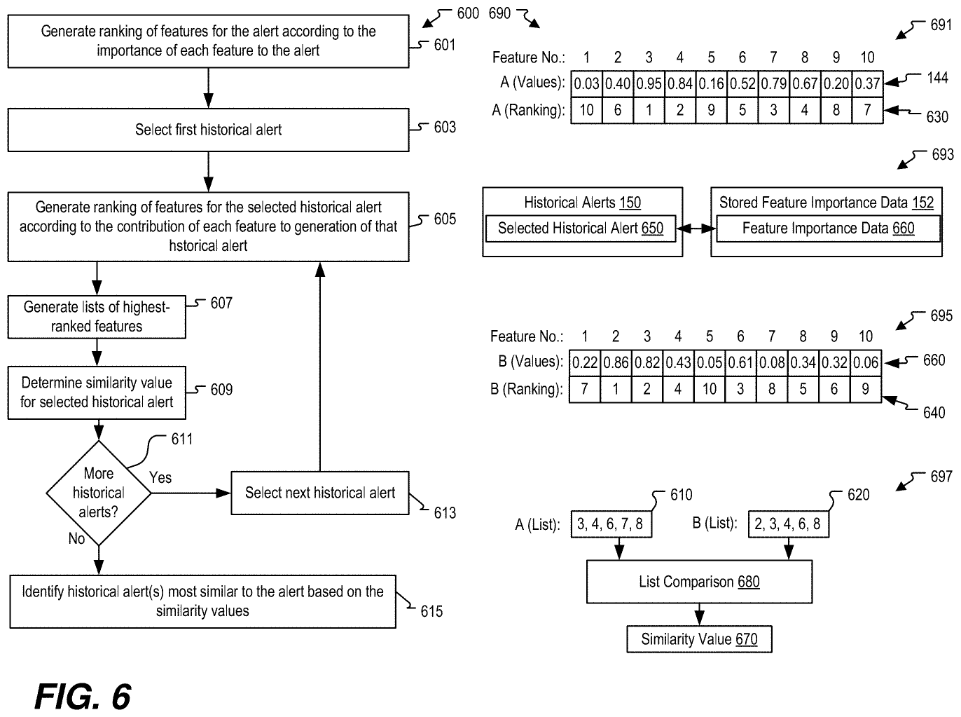

The alert manager 184 is configured to determine, based on a second portion of the feature data 120 that is subsequent to the first portion in the time sequence of the feature data 120, a metric 156 corresponding to second feature importance data 154 associated with the second portion (“2nd Portion FI Data”) of the feature data 120. For example, the metric 156 can include a similarity measure indicating an amount of difference between the second feature importance data 154 and the first alert feature importance data 144. Examples of similarity measures are described with reference to FIG. 4, FIG. 5, and FIG. 6.

The alert manager 184 is configured to determine, based on a comparison of the metric 156 to the first alert threshold 146, whether the second portion of the feature data 120 corresponds to the first alert 126 or to another alert that is distinct from the first alert 126. In response to determining that the second portion corresponds to another alert, the alert manager 184 generates the second alert 128 and a second alert threshold corresponding to the second alert 128, and proceeds to check whether subsequent portions of the feature data 120 are continuations of the second alert 128 or are sufficiently different from the second alert 128 to be labelled as a third alert. The alert manager 184 provides information associated with the identified one or more successive alerts in an alert output 186 for output to the display device 108.

A diagram 101 graphically depicts an example of the feature data 120, an example of the feature importance data 140, and the graph 103, to illustrate an example of operations associated with the alert manager 184. The feature data 120 is illustrated as a time series of sets of feature data that are received in a sequence in which a first set of feature data D1 corresponds to a first set of sensor data for a first time, a second set of feature data D2 corresponds to a second set of sensor data for a second time that sequentially follow the first time, and so on. Each set of the feature data 120 can be processed in real-time as it is received from the sensor devices 106. For each set of the feature data 120, a corresponding set of feature importance data 140 may be generated by the feature importance analyzer 182, such as a first set of feature importance data FI1 corresponding to the first set of feature data D1, a second set of feature importance data FI2 corresponding to the second set of feature data D2, and so on. According to some implementations, the feature importance data 140 indicates, for each feature, an amount or significance of deviation of that feature's value in the feature data 120 from the normal or expected values of that feature.

The graph 103 depicts feature importance distance values 132 (also referred as “points”) for each set of the feature importance data 140. The horizontal axis of the graph 103 corresponds to time, and each point in the graph 103 is vertically aligned with its associated set in the feature data 120 and in the feature importance data 140. The vertical axis of the graph 103 indicates an amount of deviation (also referred to as “distance”) that the feature importance data 140 exhibits relative to the normal or expected values of the feature importance data 140 that are associated with non-anomalous operation. Thus, a feature importance distance value 132 of zero (corresponding to a point on the horizontal axis) indicates a normal operating state, and the greater the distance of a feature importance distance value 132 above the horizontal axis, the greater the extent of anomalous behavior exhibited in the underlying set of feature data 120.

As illustrated, the first five feature data sets D1-D5 are associated with feature importance distance values 132 that are below an alert threshold 134, and the remaining feature data sets D6-D14 are associated with feature importance distance values that are greater than the alert threshold 134. The transition from the normal behavior exhibited by D1-D5 to the abnormal behavior exhibited by D6 causes the alert generator 180 to determine the alert 131 and to generate the alert indicator 130. The alert indicator 130 signals the end of a normal regime 136 of operation and the start of an alert regime 138 of operation. Although the feature importance data 140 is illustrated as including the feature importance data sets FI1-FI5 corresponding to non-anomalous operation (e.g., prior to generating the alert 131), in other implementations the feature importance analyzer 182 does not generate feature importance data 140 prior to generation of the alert indicator 130.

In response to the alert indicator 130, the alert manager 184 generates the first alert 126.

The first alert feature importance data 144 is initialized based on the feature importance data set FI6. The first alert feature importance data 144 includes values indicating relative importance of each of the sensor devices 106 to the alert indication 130. The alert manager 184 also generates a value of the first alert threshold 146 associated with D6. The first alert threshold 146 indicates a boundary of an expected range of values of feature importance data that are indicative of the first alert 126, illustrated as a sharded region indicating a first range 170.

Feature data sets D7-D10 sequentially follow D6 and are individually processed to determine whether each of the feature data sets D7-D10 corresponds to the first alert 126. When each of the feature data sets D7-D10 is determined to correspond to the first alert 126, the alert manager 184 may update the first alert feature importance data 144, the first alert threshold 146, or both, based on that feature data set. For example, after generating the first alert 126, the feature data set D7 is processed to generate the corresponding set FI7 of the feature importance data 140. The alert manager 184 determines the metric 156 indicating an amount of difference between the values of FI7 and the values of the first alert feature importance data 144. If the metric 156 for FI7 does not exceed the first alert threshold 146 (e.g., the feature importance distance value 132 for FI7 is within the first range 170), the first alert 126 continues. The first alert feature importance data 144 may be dynamically updated based on a combination of the values of FI6 and FI7, and the first alert threshold 146 may also be dynamically updated, such as by decreasing the first alert threshold 146 to indicate greater confidence as additional points are added to the first alert 126. The feature data sets D8-D10 are also sequentially processed, the values of the metric 156 associated with each of D8-D10 are determined to be within the first range 170 and therefore associated with the first alert 126, and the first alert feature importance data 144 and the first alert threshold 146 may also be dynamically updated based on the additional points added to the first alert 126.

As illustrated, for feature data set D11, the associated set of feature importance data FI11 is determined to have a corresponding value of the metric 156 that exceeds the first alert threshold 146. As a result, the alert manager 184 generates the second alert 128, second alert feature importance data based on FI11, and a second alert threshold 178 indicative of a boundary of a second range 174, in a similar manner as described for the first alert 126. Feature data sets D12-D14 are sequentially received following Dll and processed to determine whether they are associated with the second alert 128 (e.g., the corresponding values of the metric 156 do not exceed the second alert threshold 178) or whether a third alert is to be generated.

The display interface 116 is coupled to the one or more processors 112 and configured to provide a graphical user interface (GUI) 160 to the display device 108. For example, the display interface 116 provides the alert output 186 as a device output signal 188 to be displayed via the graphical user interface 160 at the display device 108. The graphical user interface 160 includes information 158 regarding the first alert 126, such as a label 164 and an indication 166 of a diagnostic action 168, a remedial action 172, or a combination thereof, such a label and diagnostic action associated with one or more of the historical alerts 150 identified as being similar to the first alert 126. The graphical user interface 160 also includes information 190 regarding the second alert 128, such as a label 192 and an indication 194 of a diagnostic action 168, a remedial action 172, or a combination thereof, such a label and diagnostic action associated with one or more of the historical alerts 150 identified as being similar to the second alert 128. Although information associated with two alerts is depicted at the graphical user interface 160, labels or actions for any number of alerts identified by the alert manager 184 may be provided at the graphical user interface 160.

During operation, the sensor devices 106 monitor operation of the device 104 and stream or otherwise provide the feature data 120 to the alert management device 102. The feature data 120 is provided to the alert generator 180, which may apply one or more models to the feature data 120 to determine whether a deviation from an expected operating state of the device 104 is detected. In response to detecting the deviation, the alert generator 180 generates the alert 131 and may provide the alert indicator 130 to the feature importance analyzer 182 and the alert manager 184.

The feature importance analyzer 182 receives the alert indicator 130 and the feature data 120 and generates the set of feature importance data 140 for the set of feature data 120 that trigged the alert 131 (e.g., by generating FI6 based on D6) and continues generating sets of the feature importance data 140 for each set of the feature data 120 received while the alert 131 is ongoing (e.g., based on the presence of the alert indicator 130).

While the alert 131 is ongoing, the alert manager 184 processes each successively received set of the feature importance data 140 and may selectively generate a new alert or dynamically update an alert thresholds of an existing alert, as described above with reference to the alert manager 184 and the graph 103. For example, the alert manager 184 determines, based on a first portion 122 of the feature data 120 corresponding to the first alert 126, the first alert feature importance data 144 of the first alert 126 associated with the first portion 122 of the feature data. Upon receiving the feature importance data set Fill corresponding to a second portion 124 (e.g., D11) of the feature data 120, the alert manager 184 determines the metric 156 corresponding to the second feature importance data 154 (e.g., FI11) and compares the metric 156 to the first alert threshold 146 to determine whether the second portion 124 (e.g., D11) corresponds to the first alert 126 or corresponds to another alert that is distinct from the first alert 126. Upon determining that the second portion (e.g., D11) does not correspond to the first alert 126, the alert manager 184 ends the first alert 126 and generates the second alert 128.

In response to the feature data 120 indicating a return to normal operation (e.g., a transition from the alert regime 138 back to a normal regime), the alert generator 180 ends the alert 131 and terminates the alert indicator 130. Termination of the alert indicator 130 causes the alert manager 184, and in some implementations the feature importance analyzer 182, to halt operation.

Upon identifying the first alert 126 and the second alert 128, in some implementations, the one or more processors 112 perform automated label-transfer using feature importance similarity to previous alerts. For example, the one or more processors 112 can identify one or more of the historical alerts 150 that are determined to be most similar to the first alert 126 and one or more of the historical alerts 150 that are determined to be most similar to the second alert 128, such as described further with reference to FIG. 5. The alert output 186 is generated, resulting in data associated with the first alert 126 and the second alert 128 being displayed at the graphical user interface 160 for use by the operator 198. For example, the graphical user interface 160 may provide the operator 198 with feature importance data associated with each of the first alert 126 and the second alert 128, a first list of 5-10 alerts of the historical alerts 150 that are determined to be most similar to the first alert 126, a second list of 5-10 alerts of the historical alerts 150 that are determined to be most similar to the second alert 128, or both. For each of the historical alerts displayed, a label associated with the historical alert and one or more actions, such as one or more of the diagnostic actions 168, one or more of the remedial actions 172, or a combination thereof, may be displayed to the operator 198.

The operator 198 may use the information displayed at the graphical user interface 160 to select one or more diagnostic or remedial actions associated with each of the first alert 126 and the second alert 128. For example, the operator 198 may input one or more commands to the alert management device 102 to cause a control signal 197 to be sent to the control device 196. The control signal 197 may cause the control device 196 to modify the operation of the device 104, such as to reduce or shut down operation of the device 104. Alternatively or in addition, the control signal 197 may cause the control device 196 to modify operation of another device, such as to operate as a spare or replacement unit to replace reduced capability associated with reducing or shutting down operation of the device 104.

Although the alert output 186 is illustrated as being output to the display device 108 for evaluation and to enable action taken by the operator 198, in other implementations remedial or diagnostic actions may be performed automatically, e.g., without human intervention. For example, in some implementations, the alert management device 102 selects, based on the identifying one or more of the historical alerts 150 similar to the first alert 126 or the second alert 128, the control device 196 of multiple control devices to which the control signal 197 is sent. To illustrate, in an implementation in which the device 104 is part of a large fleet of assets (e.g., in a wind farm or refinery), multiple control devices may be used to manage groups of the assets. The alert management device 102 may select the particular control device(s) associated with the device 104 and associated with one or more other devices to adjust operation of such assets. In some implementations, the alert management device 102 may identify one or more remedial actions based on a most similar historical alert and automatically generate the control signal 197 to initiate one or more of the remedial actions, such as to deactivate or otherwise modify operation of the device 104.

By identifying multiple successive alerts that occur during a period of anomalous behavior of the device 104, accuracy of diagnosing the anomalous behavior is improved. In particular, a likelihood of misdiagnosing, or incompletely diagnosing, multiple successive sets of factors contributing to the period of anomalous behavior is reduced (or eliminated) as compared to techniques that analyze the period of anomalous behavior as attributable to a single set of factors.

In addition, by determining alert similarity based on comparisons of the feature importance data for each alert identified by the alert manager 184, such as the first alert feature importance data 144, to the stored feature importance data 152 for the historical alerts 150, the system 100 accommodates variations over time in the raw sensor data associated with the device 104, such as due to repairs, reboots, and wear, in addition to variations in raw sensor data among various devices of the same type. Thus, the system 100 enables improved accuracy, reduced delay, or both, associated with troubleshooting of alerts.

Reduced delay and improved accuracy of diagnosing alerts can result in substantial reduction of time, effort, and expense incurred in troubleshooting. As an illustrative, non-limiting example, an alert associated with a wind turbine may conventionally require rental of a crane and incur significant costs and labor resources associated with inspection and evaluation of components in a troubleshooting operation that may span several days. In contrast, troubleshooting using the system 100 to perform automated label-transfer using feature importance similarity to previous alerts for that wind turbine, previous alerts for other wind turbines of similar types, or both, may generate results within a few minutes, resulting in significant reduction in cost, labor, and time associated with the troubleshooting. In addition, by separately identifying and diagnosing multiple successive alerts during a period of anomalous behavior of the device 104, the occurrence of incomplete or ineffective diagnostic or remedial actions for the anomalous behavior is reduced or eliminated, reducing or eliminating an amount of consecutive attempts in which a remedial action is performed and the device 104 is returned to operation, only to be taken back offline (and potentially damaged) as additional alerts are generated due to unresolved factors. Use of the system 100 may enable a wind turbine company to retain fewer SMEs, and in some cases a SME may not be needed for alert troubleshooting except to handle never-before seen alerts that are not similar to the historical alerts. Although described with reference to wind turbines as an illustrative example, it should be understood the system 100 is not limited to use with wind turbines, and the system 100 may be used for alert troubleshooting with any type of monitored asset or fleet of assets.

Although FIG. 1 depicts the display device 108 as coupled to the alert management device 102, in other implementations the display device 108 is integrated within the alert management device 102. Although the alert management device 102 is illustrated as including the alert generator 180, the feature importance analyzer 182, and the alert manager 184, in other implementations the alert management device 102 may omit one or more of the alert generator 180, the feature importance analyzer 182, or the alert manager 184. For example, in some implementations, the alert generator 180 is remote from the alert management device 102 (e.g., the alert generator 180 may be located proximate to, or integrated with, the sensor devices 106), and the alert indicator 130 is received at the feature importance analyzer 182 via the transceiver 118. Although the system 100 includes a single device 104 coupled to the alert management device 102 via a single set of sensor devices 106, in other implementations the system 100 may include any number of devices and any number of sets of sensor devices. Further, although the system 100 includes the control device 196 responsive to the control signal 197, in other implementations the control device 196 may be omitted and adjustment of operation of the device 104 may be performed manually or via another device or system.

Although the alert management device 102 is described as identifying and outputting one or more similar historical alerts 150 to identified alerts, in other implementations the alert management device 102 does not identify similar historical alerts. For example, similar historical alerts may be identified by the operator 198 or by another device, or may not be identified. Although the alert manager 184 is described as processing each successive set of the feature importance data 140 individually to determine whether that set corresponds to the ongoing alert, in other implementations the alert manager 184 processes portions of the feature importance data 140 that each includes multiple sets of feature importance data. For example, the alert manager 184 may combine (e.g., using an average, weighted average, etc.) the values of pairs of consecutive sets of the feature importance data 140, such as FI6 and FI7 to generate the second feature importance data 154, followed by combining FI7 and FI8 to generate the next second feature importance data 154, and so on.

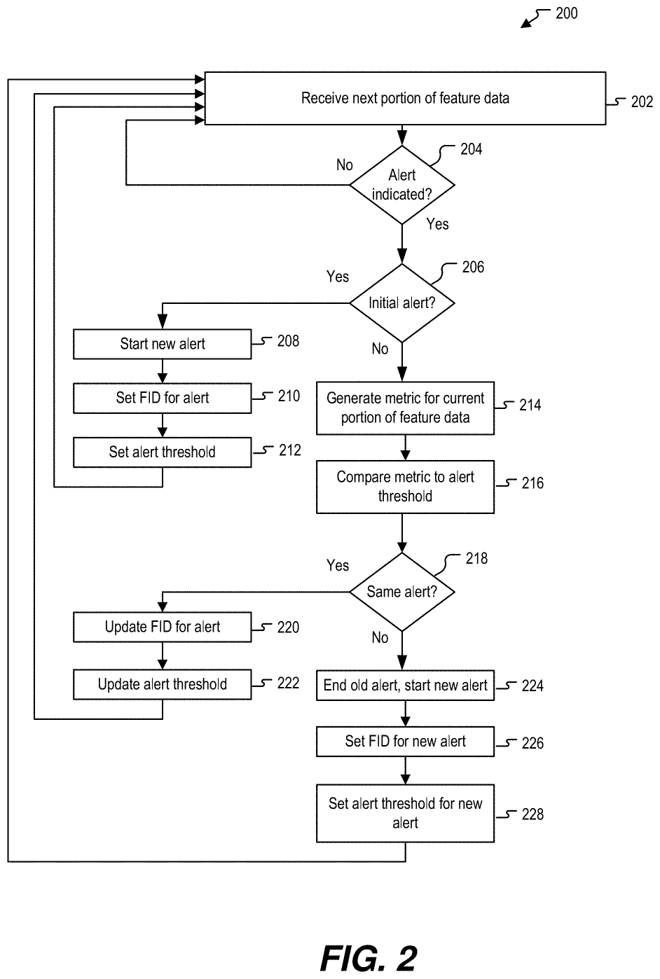

FIG. 2 depicts an example of a method 200 of identifying successive alerts associated with a detected deviation from an operational state of a device. In a particular implementation, the method 200 is performed by the alert management device 102 of FIG. 1, such as by the alert manager 184.

The method 200 includes, at 202, receiving a portion of feature data. For example, the portion of the feature data may correspond to a set of the feature importance data of 140 of FIG. 1. The method 200 includes, at 204, making a determination as to whether an alert is indicated. For example, the alert manager 184 may determine whether the alert indicator 130 has been generated. In response to determining that an alert is not indicated, the method 200 returns to 202, where a next portion of the feature data is received. Otherwise, in response to determining that an alert is indicated, the method 200 includes making a determination, at 206, as to whether the portion of feature data corresponds to an initial alert. For example, in response to the alert generator 180 of FIG. 1 setting the alert indicator 130 responsive to processing the set of feature data D6 of FIG. 1, the alert manager 184 determines that the feature data D6 corresponds to an initial alert associated with the alert indicator 130.

In response to determining, at 206, that the portion of the feature data is associated with an initial alert, the method 200 includes starting a new alert, at 208, setting feature importance data for the new alert, at 210, and setting an alert threshold, at 212. For example, the alert manager 184 generates the first alert 126 of FIG. 1, sets the first alert feature importance data 144, and sets the first alert threshold 146. After setting the alert threshold, the method 200 returns to 202, where a next portion of the feature data is received.

Otherwise, in response to determining, at 206, that the portion of feature data is not associated with an initial alert, the method 200 includes generating a metric for the current portion of the feature data, at 214. For example, the alert manager 184 generates the metric 156 corresponding to the second feature importance data 154 (e.g., the feature importance data associated with the portion of the feature data).

The method 200 includes, at 216, comparing the metric to the alert threshold. For example, the alert manager 184 compares the metric 156 to the first alert threshold 146. A determination is made, at 218, as to whether the portion of the feature data is associated with the same alert or whether the portion of the feature data is associated with a new alert. For example, when the metric 156 exceeds the first alert threshold 146, the alert manager 184 determines that the portion of the feature data is associated with a new alert, and when the metric 156 is less than or equal to the first alert threshold 146, the alert manager 184 determines that the portion of the feature data is associated with the same alert.

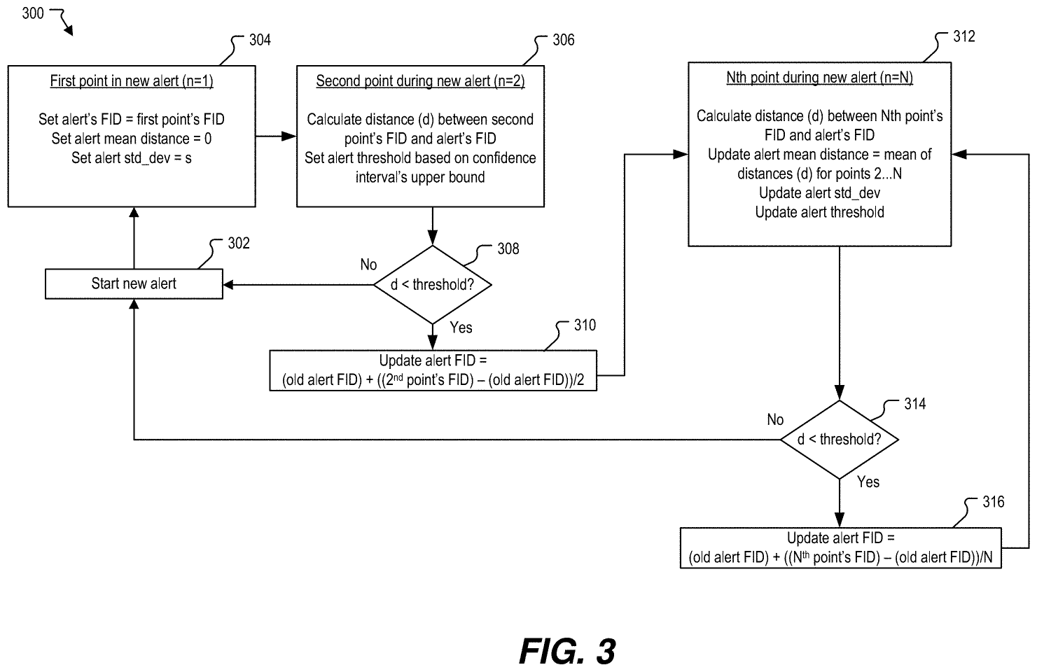

The method 200 includes, in response to determining, at 218, that the portion of the feature data is associated with the same alert, updating the feature importance data for the alert, at 220, and updating the alert threshold, at 222. For example, the alert manager 184 may adjust the first alert feature importance data 144, such as by calculating an average, weighted sum, or other value to update the first alert feature importance data 144 with the second feature importance data 154. As described further with reference to FIG. 3, the alert manager 184 may adjust the value of the alert threshold based on the number of points associated with the current alert. For example, as described with respect to FIG. 3, the alert manager 184 may update the first alert threshold 146 based on a confidence interval associated with the increased number of points in the current alert. After updating the alert threshold, at 222, the method 200 returns to 202, where a next portion of the feature data is received.

The method 200 includes, in response to determining, at 218, that the portion of the feature data is not associated with the same alert, ending the old alert and starting a new alert, at 224. For example, the alert manager 184, in response to the metric associated with feature importance set Fill exceeding the first alert threshold 146, ends the first alert 126 and starts the second alert 128. Feature importance data for the new alert is generated, at 226, and an alert threshold for the new alert is generated, at 228. For example, the feature importance data for the new alert may be determined based on the feature importance data values for the portion of feature data that triggered the new alert. The alert threshold may be set as a default value or based on one or more historic threshold values. Additional details corresponding to a particular implementation of setting feature importance data and an alert threshold for the new alert are described with respect to FIG. 3. After initializing the new alert, at 224-228, the method 200 returns to 202, where a next portion of the feature data is received.

By setting feature importance data and alert thresholds each time a new alert is detected, and updating the feature importance data and alert thresholds as additional points are received, the method 200 enables dynamic adjustment of alert parameters to more accurately distinguish between sets of feature data that are associated with the ongoing alert and sets of feature data that represent a distinct anomalous operational state that is associated with a different alert.

By comparing feature importance values associated with each received portion of feature data to the feature importance data for the current alert to generate a metric, and determining whether a new alert has begun by comparing the metric to the alert threshold, the method 200 enables dynamic thresholding to identify a sequence of successive alerts that occur during a single alert period.

Although the method 200 depicts updating the alert feature importance data, at 220, and updating the alert threshold, at 222, based on determining that the portion of feature data corresponds to the current alert, in other implementations the alert feature importance data, the alert threshold, or both, may not be updated after being initialized when a new alert is generated. Although the method 200 depicts operations performed in a particular order, in other implementations one or more such operations may be performed in a different order, or in parallel. For example, starting the new alert, at 208, setting the alert feature importance data, at 210, and setting the alert threshold, at 212, may be performed in parallel or in another order than illustrated in FIG. 2.

FIG. 3 depicts an example of a method 300 of identifying successive alerts associated with a detected deviation from an operational state of a device. In a particular implementation, the method 300 is performed by the alert management device 102 of FIG. 1, such as by the alert manager 184.

The method 300 includes, at 302, starting a new alert. For example, the alert manager 184 generates the first alert 126 in response to a determination that the feature importance data set FI6 associated with the feature data set D6 is associated with a new alert.

The methods 300 includes, at 304, performing operations associated with processing a first point in a new alert. For example, the alert manager 184 may track a count of points n corresponding to anomalous behavior, with the first point of the new alert corresponding to n =1. A feature importance data for the alert is initialized to be equal to the feature importance data of the first point of the alert. For example, the first alert feature importance data 144 is initialized to match the feature importance data set FI6 of FIG. 1. An alert mean distance μ is set to a default value, such as zero. An alert standard deviation σ (“std_dev”) corresponds to an amount of variation in the points (also referred to as “samples”) that are associated with the new alert and is set to a default value s (e.g., a configurable parameter).

The method 300 includes, at 306, performing operations associated with processing a second point (n=2) in the new alert. The operations include calculating a distance (d) between the second point's feature importance data and the alerts feature importance data. For example, the distance may be determined based on a feature-by-feature processing of sets of feature importance data, such as using cosine similarity. An example of feature-by-feature processing to compare two sets of feature importance values is described in further detail with reference to FIG. 4 and FIG. 5. In a particular implementation, the distance is determined by obtaining a set f1 of a predetermined number (e.g., 20) most important features for the alert using the alert's feature importance data; obtaining a set f2 of the predetermined number (e.g., 20) most important features for the second point using the second point's feature importance data; generating a set f as the union of f1 and f2; generating a vector a1 by subsetting the feature importance values of the features in set f for the alert; generating a vector a2 by subsetting the feature importance values of the features in set f for the second point; and calculating the distance d as the cosine distance between a1 and a2. As another example, the distance may be determined based on a comparison of lists of most important feature importance values. An example of determining a distance between two sets of feature importance values based on comparing lists of most important feature importance values is described in further detail with reference to FIG. 6.

The operations include setting the alert threshold equal to an upper bound of a confidence interval. In a particular implementation, the 95% (a=0.05) confidence interval is used where the lower bound is zero (the smallest difference between two sets of feature importance values). The upper bound ub may be calculated based on the mean of the distance of the n points' feature importance values from the alert's feature importance data, a sample standard deviation of each point from the alert mean distance, a student's t-statistic, and an uncertainty in the sample standard deviation, such as described further with respect to “step 2” of the process described below.

The method 300 includes, at 308, determining whether the distance for the second point (n=2) is less than the alert threshold. In response to determining that the distance is not less than the alert threshold, the method 300 starts a new alert, at 302. Otherwise, in response to determining that the distance is less than the threshold, the method 300 includes, at 310, updating the alert feature importance data. For example, the alert feature importance data (“FID”) is updated for the second point according to: (updated alert FID)=(old alert FID)+((2nd point's FID)-(old alert FID))/2. Also at 310, the distance calculated for the new point may be stored for use in updating values of the alert, such as the alert mean distance, standard deviation, and alert threshold.

The method 300 includes, at 312, performing operations associated with an Nth point during the new alert, where N>2. A distance is calculated between the new point's feature importance data and the alert feature importance data. The alert mean distance μ is set equal to a mean of the distances computed for each of the points from n=2 to n=N. The alert's standard deviation is updated, an updated upper bound is calculated, and the alert threshold is set equal to the updated upper bound.

The method 300 includes, at 314, determining whether the distance associated with the new point is less than the alert threshold. In response to determining that the distance is not less than the alert threshold, the method 300 includes starting a new alert, at 302. Otherwise, in response to determining that the distance is less than the threshold, the alert feature importance data is updated, at 316. Also at 316, the distance calculated for the new point may be stored for use in updating values of the alert (e.g., alert mean distance, standard deviation, and alert threshold) after adding the new point. For example, a list of previously calculated distances may be stored, and the distance calculated for new point may be appended to the list. After updating the alert feature importance data, at 316, the method advances to 312, where a next point received during the new alert is processed.

As described above, the distance calculated for each new point may be stored in a list for later use in updating values for the alert. Because the alert feature importance data is updated as each point is added, each of the stored distances is based on values of the alert feature importance data at previous times, rather than the current value of the alert feature importance data. In other implementations, the distances associated with the earlier points can be re-calculated each time the alert feature importance data is updated.

In a particular implementation, a process is performed when an alert has n anomalies (e.g., n points in the alert) and the (n+1)^{th} anomaly is encountered to determine whether the (n+1)^{th} anomaly is part of the previous alert or is the start of a new alert, according to the following four steps.

Step 1: Calculate the distance, d, of this anomaly from the alert by calculating the cosine distance between the anomaly feature importance and the alert feature importance. In some implementations, the distance can be calculated according to the following non-limiting example:

1. Obtain the set of top 20 features for the alert using the alert's feature importance, referred to as f1.

2. Obtain the set of top 20 features for the anomaly using the anomaly's feature importance, referred to as f2.

3. Take the union of the two feature sets f1 and f2, referred to as set f.

4. Subset the feature importances of the features in set f for both the alert and the (n+1)^{th} anomaly to generate vectors a1 and a2, respectively.

5. Calculate the cosine distance d between the two vectors a1 and a2.

Step 2: Calculate the 95% (α=0.05) confidence interval where the lower bound is 0.0.

The upper bound ub is calculated as:

ub=μ+\hat{σ}·t_{n,(1-∝/2)}+k·σ_{\hat{σ}}.

In the above equation,

$$μ = \frac{{\sum }_{i = 1}^{n} {d}_{i}}{n}$$

is the mean of the distance of the n anomalies' feature importances from the alert's feature importance. The mean is zero for first two anomalies and the average of distances between the n−1 anomalies for n^{th} anomaly when n >2. In some implementations, each value of d is computed once and stored, and dᵢ represents distances based on the alert's feature importances as they were at previous times. In other implementations, dᵢ are re-calculated each time the alert feature importance is updated, so that μ represents the mean distance of each point from the current alert feature importance.

$$\hat{σ} = \{ \begin{matrix}\sqrt{\frac{{\sum }_{i = 1}^{n} {( {d}_{i} - μ )}^{2}}{n - 1}} : n > 2 : n > 2 \\ s : n \leq 2\end{matrix}$$

is the sample standard deviation with a default value of s when for alerts with less than three anomalies.

t is the student's t-statistic.

α is the false positive rate leading to a (1−α)·100%=95% confidence interval.

$${σ}_{\hat{σ}} = Var [ {\hat{σ}}^{2} ] = \frac{1}{n} ( {µ}_{4} - \frac{n - 3}{n - 1} \cdot {\hat{σ}}^{4} )$$

is the uncertainty in the sample standard deviation. The original formulation is for population standard deviation a and not for sample standard deviation \hat{σ}. It uses the fourth central moment μ₄=Σᵢ₌₁ⁿ(dᵢ−μ)⁴. Adding this uncertainty to the confidence interval's upper bound makes the confidence interval more robust to minor errors and accommodates distances within the confidence interval with some error, which helps reduce false negatives and increase true positives.

k is the number of uncertainties of the sample standard deviation to add to the upper bound (e.g., k=1).

Parameters s, a , and k are configurable and can be set to values that result in reduced false positives (e.g., points incorrectly determined to be outside of the existing alert), decrease the f-score, and so on. In an illustrative example, k is set to 1, s is set to a value less than 1, and a has a value in the range of 90-99%, such as 95%.

Step 3:

Case 1: if d ≤ub, define the (n−1)^{th} anomaly to be part of the ongoing alert and define the new alert feature importance to be the average of all the feature importance values of all the anomalies in the alert so far. This may be referred to as the online mean and calculated as:

$${\overline{a}}_{n + 1} = {\overline{a}}_{n} + \frac{{a}_{n + 1} - {\overline{a}}_{n}}{n + 1} ,$$

where aᵢᵢ₊ₗis the updated alert feature importance data, α̅ₙis the alert feature importance data with n anomalies, and αₙ₊₁ is the feature importance data of the (n+1)^{th} anomaly being freshly appended to the ongoing alert. This online mean can be used to reduce memory usage by not requiring storage of the feature importances for all of the anomalies in an alert.

Case 2: if d >ub, declare the beginning of a new alert and define the new alert feature importance to be the feature importance of this (n−1)^{th} anomaly.

Step 4: Encounter the (n+2)^{nd} anomalous point and go back to step 1.

By comparing feature importance values associated with each new point to the feature importance data for the current alert, and determining whether a new alert has begun based on whether the difference exceeds a threshold for the existing alert, the method 300 and the example process described above enable dynamic thresholding to distinguish between different successive alerts associated with a sequence of anomalous points.

FIG. 4 illustrates a flow chart of a method 400 and associated diagrams 490 corresponding to operations to find historical alerts most similar to a detected alert that may be performed in the system 100 of FIG. 1, such as by the alert management device 102, according to a particular implementation. The diagrams 490 include a first diagram 491, a second diagram 493, and a third diagram 499.

The method 400 includes receiving an alert indicator for a particular alert, alert k, where k is a positive integer that represents the particular alert. For example, alerts identified over a history of monitoring one or more assets can be labelled according to a chronological order in which a chronologically first alert is denoted alert 1, a chronologically second alert is denoted alert 2, etc. In some implementations, alert k corresponds to the alert 131 of FIG. 1 that is generated by the alert generator 180 and that corresponds to the alert indicator 130 that is received by the feature importance analyzer 182 in the alert management device 102.

The first diagram 491 illustrates an example graph of a particular feature of the feature data 120 (e.g., a time series of measurement data from a single one of the sensor devices 106), in which a thick, intermittent line represents a time series plot of values of the feature over four measurement periods 483, 484, 485, and 486. In the three prior measurement periods 483, 484, and 485, the feature values maintain a relatively constant value (e.g., low variability) between an upper threshold 481 and a lower threshold 482. In the most recent measurement period 486, the feature values have a larger mean and variability as compared to the prior measurement periods 483, 484, and 485. A dotted ellipse indicates a time period 492 in which the feature data crosses the upper threshold 481, triggering generation of an alert (e.g., the alert 131) labeled alert k. Although the first diagram 491 depicts generating an alert based on a single feature crossing a threshold for clarity of explanation, it should be understood that generation of an alert may be performed by one or more models (e.g., trained machine learning models) that generate alerts based on evaluation of more than one (e.g., all) of the features in the feature data 120.

The method 400 includes, at 403, generating feature importance data for alert k. For example, the feature importance analyzer 182 generates the feature importance data 140 as described in FIG. 1. Based on the feature importance data during the time period associated with alert k, the alert manager 184 may detect multiple successive distinct alerts, labeled alert kl (e.g., the first alert 126) and alert k2 (e.g., the second alert 128). In some implementations, the alert manager 184 determines alert feature importance data 488 of for alert k1, for each of four illustrative features F1, F2, F3, F4, across the portion of the time period 492 corresponding to alert kl, and alert feature values 489 for alert k2 across the portion of the time period 492 corresponding to alert k2. The set of alert feature importance data 488 corresponding to alert k1 and alert feature values 489 corresponding to alert k2 are illustrated in a first table 495 in the second diagram 493. It should be understood that although four features F1-F4 are illustrated, in other implementations any number of features (e.g., hundreds, thousands, or more) may be used. Although two alerts are illustrated for the time period 492 associated with alert k, in other implementations any number of alerts may be identified for the time period 492.

The method 400 includes, at 405, finding historical alerts most similar to alert kl, such as described with reference to the alert management device 102 of FIG. 1 or in conjunction with one or both of the examples described with reference to FIG. 5 and FIG. 6. The second diagram 493 illustrates an example of finding the historical alerts that includes identifying the one or more historical alerts based on feature-by-feature processing 410 of the values in the alert feature importance data 488 with corresponding values 460 in the stored feature importance data 152. The stored feature importance data 152 is depicted in a second table 496 as feature importance values for each of 50 historical alerts (e.g., k=51).

In an illustrative example, identifying one or more historical alerts associated with alert kl includes determining, for each of the historical alerts 150, a similarity value 430 based on feature-by-feature processing 410 of the values in the alert feature importance data 488 with corresponding values 460 in the stored feature importance data 152 corresponding to that historical alert 440. An example of feature-by-feature processing to determine a similarity between two sets of feature importance data is illustrated with reference to a set of input elements 497 (e.g., registers or latches) for the feature-by-feature processing 410. The alert feature importance values for alert kl are loaded into the input elements, with the feature importance value for F1 (0.8) in element a, the feature importance value for F2 (−0.65) in element b, the feature importance value for F3 (0.03) in element c, and the feature importance value for F4 (0.025) in element d. The feature importance values for a historical alert, illustrated as alert 50 440, are loaded into the input elements, with the feature importance value for F1 (0.01) in element e, the feature importance value for F2 (0.9) in element f, the feature importance value for F3 (0.3) in element g, and the feature importance value for F4 (0.001) in element h.

The feature-by-feature processing 410 generates the similarity value 430 (e.g., the metric 156) based on applying an operation to pairs of corresponding feature importance values. In an illustrative example, the feature-by-feature processing 410 multiplies the value in element a with the value in element e, the value in element b with the value in element f, the value in element c with the value in element g, and the value in element d with the value in element h. To illustrate, the feature-by-feature processing 410 may sum the resulting multiplicative products (e.g., to generate the dot product ((alert k1)·(alert 50)) and divide the dot product by (∥alert k1∥ ∥alert 50∥), where ∥alert k1∥ denotes the magnitude of a vector formed of the feature importance values of alert k1, and ∥alert 50∥ denotes the magnitude of a vector formed of the feature importance values of alert 50, to generate a cosine similarity 470 indicating an amount of similarity between alert kl and alert 50. Treating each alert as a n-dimensional vector (where n=4 in the example of FIG. 2), the cosine similarity 470 describes how similar two sets of feature importance data are in terms of their orientation with respect to each other.

In some implementations, rather than generating the similarity value 430 of each pair of alerts based on the feature importance value of every feature, a reduced number of features may be used, reducing computation time, processing resource usage, or a combination thereof. To illustrate, a particular number (e.g., 20-40) or a particular percentage (e.g., 10%) of the features having the largest feature importance values for alert kl may be selected for comparison to the corresponding features of the historical alerts. In some such implementations, determination of the similarity value 430 includes, for each feature of the feature data, selectively adjusting a sign of a feature importance value for that feature based on whether a value of that feature within the temporal window exceeds a historical mean value for that feature. For example, within the portion of the time period 492 that corresponds to alert kl, the feature value exceeds the historical mean in the measurement period 486, and the corresponding feature importance value is designated with a positive sign (e.g., indicating a positive value). If instead the feature value were below the historical mean, the feature importance value may be designated with a negative sign 480 (e.g., indicating a negative value). In this manner, the accuracy of the cosine similarity 470 may be improved by distinguishing between features moving in different directions relative to their historical means when comparing pairs of alerts.

The method 400 includes, at 407, generating an output indicating the identified historical alerts. For example, one or more of the similarity values 430 that indicate largest similarity of the similarity values 430 are identified. As illustrated in the third diagram 499, the five largest similarity values for alert k1 correspond to alert 50 with 97% similarity, alert 44 with 85% similarity, alert 13 with 80% similarity, alert 5 with 63% similarity, and alert 1 with 61% similarity. The one or more historical alerts corresponding to the identified one or more of the similarity values 450 are selected for output. Similar processing may be performed to identify and select for output one or more historical alerts corresponding to alert k2.

Although the similarity value 430 is described as a cosine similarity 470, in other implementations, one or more other similarity metrics may be determined in place of, or in addition to, cosine similarity. The other similarity metrics may be determined based on the feature-by-feature processing, such as the feature-by-feature processing 410 or as described with reference to FIG. 5, or may be determined based on other metrics, such as by comparing which features are most important from two sets of feature importance data, as described with reference to FIG. 6.

FIG. 5 illustrates a flow chart of a method 500 and associated diagrams 590 corresponding to operations that may be performed in the system of FIG. 1, such as by the alert management device 102, to identify historical alerts that are most similar to a present alert, according to a particular implementation. The diagrams 590 include a first diagram 591, a second diagram 593, a third diagram 595, and a fourth diagram 597.

The method 500 of identifying the one or more historical alerts includes performing a processing loop to perform operation for each of the historical alerts 150. The processing loop is initialized by determining a set of features most important to an identified alert, at 501. For example, the alert manager 184 generates the first alert feature importance data 144 and may determine the set of features having the largest feature importance values (e.g., a set of features corresponding to the largest feature importance values for the first alert 126). An example is illustrated in the first diagram 591, in which the first alert feature importance data 144 includes feature importance values for each of twenty features, illustrated as a vector A of feature importance values. The five largest feature importance values in A (illustrated as a, b, c, d, and e), are identified and correspond to features 3, 9, 12, 15, and 19, respectively. Features 3, 9, 12, 15, and 19 form a set 520 of the most important features for the first alert 126.

Initialization of the processing loop further includes selecting a first historical alert (e.g., alert 1 of FIG. 4), at 503. For example, in the second diagram 593, the selected historical alert 510 is selected from the historical alerts 150, and the feature importance data 560 corresponding to the selected historical alert 510 is also selected from the stored feature importance data 152.

The method 500 includes determining a first set of features most important to generation of the selected historical alert, at 505. For example, in the third diagram 595, the feature importance data 560 includes feature importance values for each of twenty features, illustrated as a vector B of feature importance values. The five largest feature importance values in vector B (illustrated as f, g, h, i, and j), are identified and correspond to features 4, 5, 9, 12, and 19, respectively. Features 4, 5, 9, 12, and 19 form a first set 512 of the most important features for the selected historical alert 510.

The method 500 includes combining the sets (e.g., combining the first set 512 of features with the set 520 of features) to identify a subset of features, at 507. For example, in the fourth diagram 597, a subset 530 is formed of features 3, 4, 5, 9, 12, 15, and 19, corresponding to the union of the set 520 and the first set 512.

The method 500 includes determining a similarity value for the selected historical alert, at 509. To illustrate, for the subset 530 of features, a similarity value 540 is generated based on feature-by-feature processing 550 of the values in the first alert feature importance data 144 with corresponding values (e.g., from the feature importance data 560) in the stored feature importance data 152 corresponding to that historical alert 510. As illustrated in the fourth diagram 597, the feature-by-feature processing 550 operates on seven pairs of values from vector A and vector B: values a and m corresponding to feature 3, values k and f corresponding to feature 4, values l and g corresponding to feature 5, values b and h corresponding to feature 9, values c and i corresponding to feature 12, values d and n corresponding to feature 15, and values e and j corresponding to feature 19. For example, the feature-by-feature processing may include multiplying the values in each pair and adding the resulting products, such as during computation of the similarity value 540 as a cosine similarity (as described with reference to FIG. 4) applied to the subset 530 of features.

The method 500 includes determining whether any of the historical alerts 150 remain to be processed, at 511. If any of the historical alerts 150 remain to be processed, a next historical alert (e.g., alert 2 of FIG. 4) is selected, at 513, and processing returns to a next iteration of the processing loop for the newly selected historical alert, at 505.

Otherwise, if none of the historical alerts 150 remain to be processed, the method 500 includes, at 515, identifying one or more historical alerts that are most similar to the alert based on the similarity values. To illustrate, the generated similarity values 540 for each historical alert may be sorted by size, and the historical alerts associated with the five largest similarity values 540 may be identified as the one or more historical alerts most similar to the first alert 126.

It should be understood that the particular example depicted in FIG. 5 may be modified in other implementations. For example, the processing loop depicted in FIG. 5 (as well as FIG. 6) is described as sequential iterative loops that use incrementing indices for ease of explanation. Such processing loops can be modified in various ways, such as to accommodate parallelism in a system that includes multiple computation units. For example, in an implementation having sufficient processing resources, all of the described loop iterations may be performed in parallel (e.g., no looping is performed). Similarly, loop variables may be initialized to any permissible value and adjusted via various techniques, such as incremented, decremented, random selection, etc. In some implementations, historical data may be stored in a sorted or categorized manner to enable processing of one or more portions of the historical data to be bypassed. Thus, the descriptions of such loops are provided for purpose of explanation rather than limitation.

FIG. 6 illustrates a flow chart of a method 600 and associated diagrams 690 corresponding to operations that may be performed in the system of FIG. 1, such as by the alert management device 102, to identify historical alerts that are most similar to a present alert, according to a particular implementation. The diagrams 690 include a first diagram 691, a second diagram 693, a third diagram 695, and a fourth diagram 697. As compared to FIG. 5, identifying one or more historical alerts is based on comparing a list 610 of features having largest relative importance to the alert to lists 620 of features having largest relative importance to the historical alerts 150.

The method 600 includes performing a processing loop to perform operations for each of the historical alerts 150. Initialization of the processing loop includes generating, based on the alert's feature importance data, a ranking 630 of the features for the alert according to the importance of each feature to the alert, at 601. For example, the alert manager 184 generates the first alert feature importance data 144 for the first alert 126, and the alert manager 184 may determine the set of features having the largest feature importance values (e.g., a set of features corresponding to the largest feature importance values for the first alert 126). An example is illustrated in the first diagram 691, in which the first alert feature importance data 144 includes feature importance values for each of ten features, illustrated as a vector A of feature importance values. Rankings 630 are determined for each feature based on the feature importance value associated with that feature. As illustrated, the largest feature importance value in vector A is 0.95, which corresponds to feature 3. As a result, feature 3 is assigned a ranking of 1 to indicate that feature 3 is the highest ranked feature. The second-largest feature importance value in vector A is 0.84 corresponding to feature 4; as a result, feature 4 is assigned a ranking of 2. The smallest feature importance value in vector A is 0.03 corresponding to feature 1; as a result, feature 1 is assigned a ranking of 10.

Initialization of the processing loop further includes selecting a first historical alert (e.g., alert 1 of FIG. 4), at 603. For example, in the second diagram 693, the selected historical alert 650 is selected from the historical alerts 150, and the feature importance data 660 corresponding to the selected historical alert 650 is also selected from the stored feature importance data 152.

The method 600 includes, at 605, generating a ranking of features for the selected historical alert according to the importance of each feature to that historical alert. For example, the third diagram 695 illustrates generating, based on the stored feature importance data for the historical alert 650, a ranking 640 of features for that historical alert according to the contribution of each feature to generation of that historical alert. In some implementations, the ranking 640 can be stored as part of the stored feature importance data 152 and may be retrieved for comparison purposes, rather than generated during runtime. The feature importance data 660 includes feature importance values for each of ten features, illustrated as a vector B of feature importance values. The features of vector B are ranked by the size of each feature's feature importance value in a similar manner as described for vector A.

The method 600 includes generating lists of highest-ranked features, at 607. For example, as illustrated in the fourth diagram 697, a list 610 has the five highest ranked features from vector A and a list 620 has the five highest ranked features from vector B.

The method 600 includes determining a similarity value that indicates similarity between the first alert feature importance data 144 and the feature importance data for the selected historical alert, at 609. As illustrated in the fourth diagram 697, a similarity value 670 is determined for the selected historical alert 650 indicating how closely the list 610 of highest-ranked features for the first alert 126 matches the list 620 of highest-ranked features for the historical alert 650.

To illustrate, a list comparison 680 may determine the amount of overlap of the lists 610 and 620, such as by comparing each feature in the first list 610 to the features in the second list 620, and incrementing a counter each time a match is found. To illustrate, features 3, 4, and 8 are present in both lists 610, 620, resulting in a counter value of 3. The count of features that are common to both lists may be output as the similarity value 670, where higher values of the similarity value 670 indicate higher similarity and lower values of the similarity value 670 indicate lower similarity. In some implementations, the similarity value 670 may be further adjusted, such as scaled to a value between 0 and 1.

The method 600 includes determining whether any of the historical alerts 150 remain to be processed, at 611. If any of the historical alerts 150 remain to be processed, a next historical alert (e.g., alert 2 of FIG. 4) is selected, at 613, and processing returns to a next iteration of the processing loop for the newly selected historical alert, at 605.

Otherwise, if none of the historical alerts 150 remain to be processed, the method 600 includes, at 615, identifying one or more historical alerts most similar to the alert based on the similarity values, at 615. As an example, one or more of the similarity values are identified that indicate largest similarity of the determined similarity values 670, and the one or more historical alerts corresponding to the identified one or more of the similarity values are selected. To illustrate, the generated similarity values 670 for each historical alert may be sorted by size, and the historical alerts associated with the five largest similarity values 670 may be identified as the most similar to the first alert 126.

In some implementations, a device (e.g., the alert management device 102) can identify historical alerts that are similar to a current alert based on techniques described with reference to FIG. 4, FIG. 5, FIG. 6, or any combination thereof. For example, in a particular implementation, the alert management device 102 calculates the similarity value 540 of FIG. 5 and the similarity value 670 of FIG. 6 for a particular historical alert and generates a final similarity value for the particular historical alert based on the similarity value 540 and the similarity value 670 (e.g., using an average or a weighted sum of the similarity value 540 and the similarity value 670).

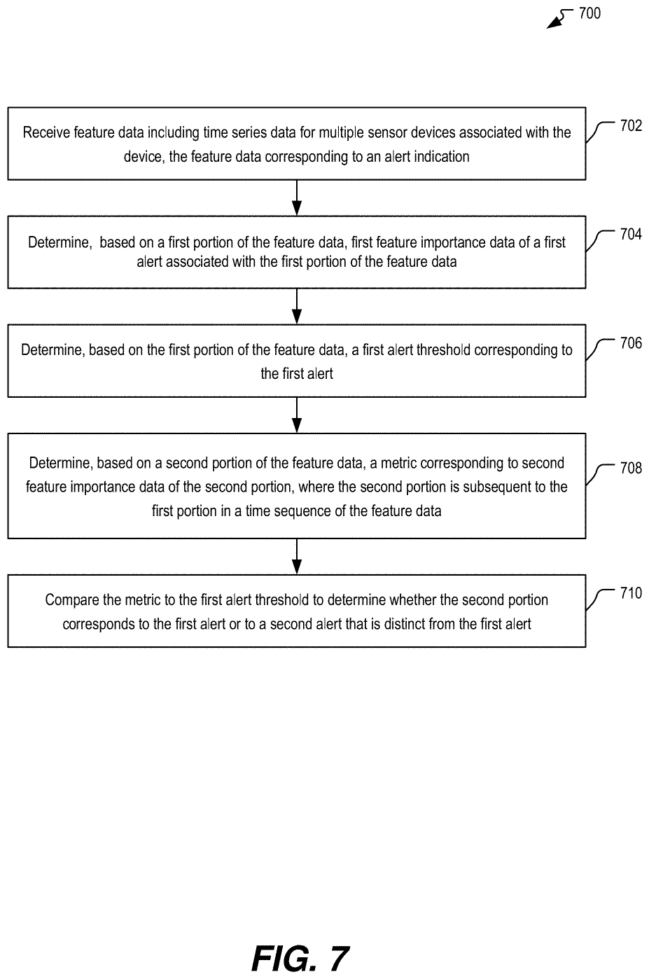

FIG. 7 is a flow chart of a method 700 of identifying successive alerts associated with a detected deviation from an operational state of a device. In a particular implementation, the method 700 can be performed by the alert management device 102, the alert generator 180, the feature importance analyzer 182, the alert manager 184, or a combination thereof.

The method 700 includes, at 702, receiving, at a processor, feature data including time series data for multiple sensor devices associated with the device, the feature data corresponding to an alert indication. For example, the feature importance analyzer 182 at the one or more processors 112 receives the feature data 120 that corresponds to the alert indicator 130 and that includes the time series data for the sensor devices 106 associated with the device 104.

The method 700 includes, at 704, determining, at the processor and based on a first portion of the feature data, first feature importance data of a first alert associated with the first portion of the feature data. For example, the feature importance analyzer 182 generates feature importance data corresponding to the first portion 122 of the feature data 120 and associated with the first alert 126, and the alert manager 184 processes the feature importance data associated with the first alert 126 to determine the first alert feature importance data 144. The first feature importance data can include values indicating relative importance of each of the sensor devices to the alert indication.

The method 700 includes, at 706, determining, at the processor and based on the first portion of the feature data, a first alert threshold corresponding to the first alert. For example, the alert manager 184 processes the feature importance data associated with the first alert 126 to determine the first alert threshold 146, such as based on a mean of distances of sets of feature importance values to the first alert feature importance data 144. The first alert threshold can indicate an amount of difference from the first feature importance data. In some implementations, the first alert threshold indicates a boundary of an expected range (e.g., the first range 170) of values of feature importance data that are indicative of the first alert.

The method 700 includes, at 708, determining, at the processor and based on a second portion of the feature data, a metric corresponding to second feature importance data of the second portion, wherein the second portion is subsequent to the first portion in a time sequence of the feature data. For example, the alert manager 184 determines the metric 156 corresponding to the feature importance data set Fill that corresponds to the second portion 124 (e.g., the feature data set D11) of the feature data 120. In some implementations, the metric indicates a similarity between values of the first feature importance data and values of the second feature importance data, such as a cosine similarity.

The method 700 includes, at 710, comparing, at the processor, the metric to the first alert threshold to determine whether the second portion corresponds to the first alert or to a second alert that is distinct from the first alert. For example, the alert manager 184 compares the metric 156 to the first alert threshold 146 to determine whether the feature data set D11 corresponds to the first alert 126 or to the second alert 128.

In some implementations, the method 700 includes, in response to determining that the second portion corresponds to the first alert, updating the first alert threshold based on the second feature importance data. For example, the alert manager 184 updates the first alert threshold 146 in response to determining that the feature data set D10 corresponds to the first alert because the feature importance data asset FI10 does not exceed the first alert threshold 146, such as by updating the upper bound of a confidence interval, as described with reference to FIG. 3. The method 700 can include, in response to determining that the second portion corresponds to the first alert, updating the first feature importance data based on the second feature importance data, such as by updating the first alert feature importance data 144 based on the feature importance data set FI10 (e.g., the “update alert FID” operation of FIG. 3).

In some implementations, the method 700 includes, in response to determining that the second portion corresponds to the second alert, generating a second alert associated with the second portion and generating a second alert threshold corresponding to the second alert. For example, the alert manager 184, in response to determining that the metric 156 exceeds the first alert threshold, determines that the second portion 124 of the feature data 120 (e.g., feature data set D11) corresponds to a second alert that is distinct from the first alert 126 and generates the second alert 176 and a second alert threshold corresponding to the second alert 176.

In some implementations, the method 700 includes selecting, based on the second alert, a control device to send a control signal to. For example, in response to determining the second alert 128, the alert management device 102 can select the control device 196 and send the control signal 197 to modify operation of the device 104.

The method 700 can also include generating an output indicating the first alert and the second alert. For example, alert manager 184 provides the alert output 186 to the display interface 116, and the display interface 116 outputs the device output signal 188 for display at the display device 108. The method 700 can include displaying a first diagnostic action or a first remedial action associated with the first alert and a second diagnostic action or a second remedial action associated with the second alert, such as the display device 108 displaying the indication 166 of the first action and the indication 194 of the second action, respectively.

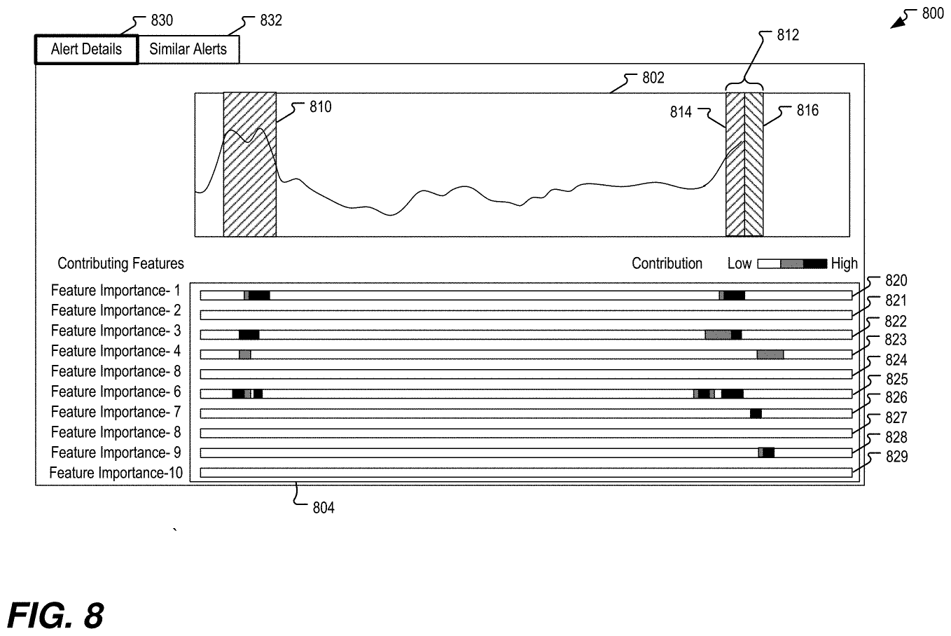

In some implementations, the method 700 also includes generating a graphical user interface that includes a graph indicative of a performance metric of the device over time, a graphical indication of the alert corresponding to a portion of the graph, and an indication of one or more sets of the feature data associated with the alert. For example, the graphical user interface described with reference to FIG. 8 may be generated at the display device 108.

By determining whether the second portion of the feature data corresponds to the first alert based on a comparison with the first alert threshold, the method 700 enables identification of multiple successive alerts that occur during a time period of the alert indication. Thus, the method 700 enables improved accuracy, reduced delay, or both, associated with diagnosing factors contributing to anomalous behavior exhibited during the time period of the alert indication.

FIG. 8 depicts an example of a graphical user interface 800, such as the graphical user interface 160 of FIG. 1 or a graphical user interface that may be displayed at a display screen of another display device, as non-limiting examples. The graphical user interface 800 includes a graph 802 indicative of a performance metric (e.g., a risk score) of the device over time. As illustrated, the graphical user interface 800 also includes a graphical indication 814 of the first alert 126 and a graphical indication 816 of the second alert 128 that occur during time period 812 associated with the alert indicator 130, and a graphical indication 810 of a prior alert, illustrated on the graph 802. The graphical user interface 800 includes an Alert Details screen selection control 830 (highlighted to indicate the Alert Details screen is being displayed) and a Similar Alerts screen selection control 832.

The graphical user interface 800 also includes an indication 804 of one or more sets of the feature data associated with the alerts corresponding to the graphical indications 810, 814, and 816. For example, a first indicator 820 extends horizontally under the graph 802 and has different visual characteristics (depicted as white, grey, or black) indicating the relative contributions of a first feature (e.g., sensor data from a first sensor device of the sensor devices 106) in determining to generate the graphical indications 810, 814, and 816. Similarly, a second indicator 821 indicates the relative contributions of a second feature in determining to generate the graphical indications 810, 814, and 816. Indicators 822-829 indicate the relative contributions of third, fourth, fifth, sixth, seventh, eighth, ninth, and tenth features, respectively, to the alerts represented by the graphical indications 810, 814, and 816. Although ten indicators 820-829 showing feature importance values for ten feature are illustrated, in other implementations fewer than ten features or more than ten features may be used.

For example, the first graphical indication 814 shows that the first feature, the third feature, and the sixth features were important to generating the alert indicator 130 and characteristic of the first alert 126, while the fourth feature, the seventh feature, and the ninth feature were characteristic of the second alert 128. Providing relative contributions of each feature of each alert can assist a subject matter expert to diagnose an underlying cause of abnormal behavior, to determine a remedial action to perform responsive to the alerts, or both.

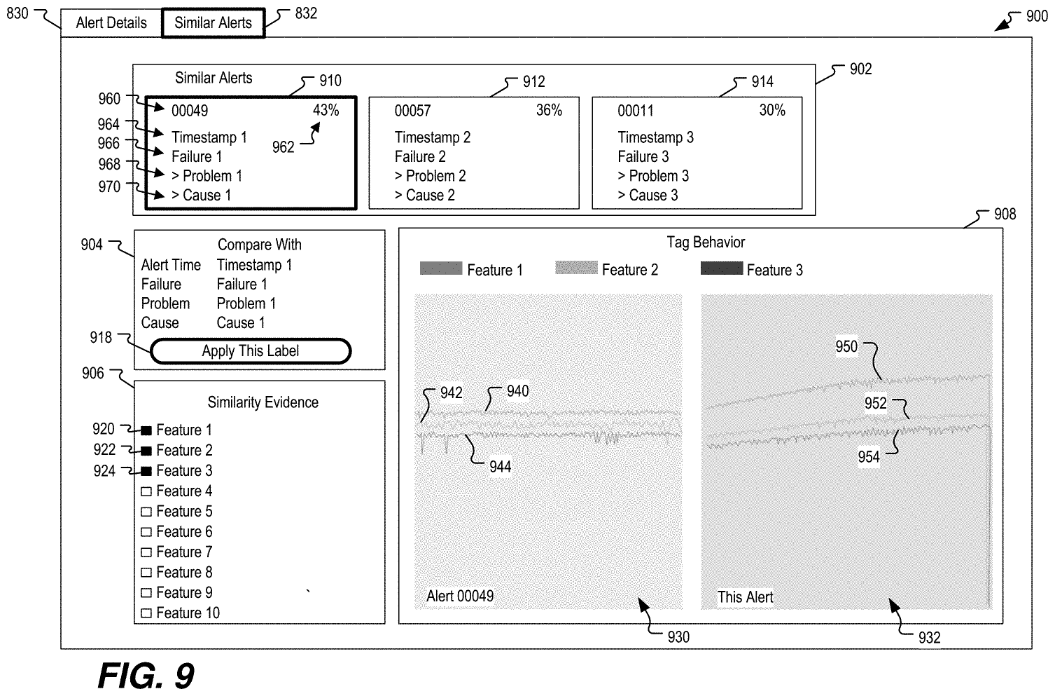

FIG. 9 depicts a second example of a graphical user interface 900, such as the graphical user interface 160 of FIG. 1 or a graphical user interface that may be displayed at a display screen of another display device, as non-limiting examples. The graphical user interface 900 includes the Alert Details screen selection control 830 and the Similar Alerts screen selection control 832 (highlighted to indicate the Similar Alerts screen is being displayed). The graphical user interface 900 includes a list of similar alerts 902, a selected alert description 904, a similarity evidence selector 906, and a comparison portion 908.

The list of similar alerts 902 includes descriptions of multiple alerts determined to be most similar to a current alert (e.g., the first alert 126), including a description of a first historical alert 910, a second historical alert 912, and a third historical alert 914. For example, the description of the first historical alert 910 includes an alert identifier 960 of the historical alert, a similarity metric 962 of the historical alert to the current alert (e.g., the similarity value 430, 540, or 670), a timestamp 964 of the historical alert, a failure description 966 of the historical alert, a problem 968 associated with the historical alert, and a cause 970 associated with the historical alert. As an illustrative, non-limiting example, in an implementation for a wind turbine, the failure description 966 may indicate “cracked trailing edge blade,” the problem 968 may indicate “surface degradation,” and the cause 970 may indicate “thermal stress.” Although descriptions of three historical alerts are illustrated, in other implementations fewer than three or more than three historical alerts may be displayed.

Each of the historical alert descriptions 910, 912, and 914 is selectable to enable comparisons of the selected historical alert to the current alert. As illustrated, the description of the first historical alert 910 is highlighted to indicate selection, and content of the description of the first historical alert 910 is displayed in the selected alert description 904. The selected alert description 904 also includes a selectable control 918 to apply the label of the selected historical alert to the current alert. For example, a user of the graphical user interface 900 (e.g., a subject matter expert) may determine that the selected historical alert corresponds to the current alert after comparing each of alerts in the list of similar alerts 910 to the current alert using the similarity evidence selector 906 and the comparison portion 908.

The similarity evidence selector 906 includes a list of selectable features to be displayed in a first graph 930 and a second graph 932 of the comparison portion 908. The first graph 930 displays values of each of the selected features over a time period for the selected historical alert, and the second graph 932 displays values of each of the selected features over a corresponding time period for the current alert. As illustrated, the user has selected a first selection control 920 corresponding to a first feature, a second selection control 922 corresponding to a second feature, and a third selection control 924 corresponding to a third feature. In response to these selections in the similarity evidence selector 906, the first feature is plotted in a trace 940 in the first graph 930 and a trace 950 in the second graph 932, the second feature is plotted in a trace 942 in the first graph 930 and a trace 952 in the second graph 932, and the third feature is plotted in a trace 944 in the first graph 930 and a trace 954 in the second graph 932.

The graphical user interface 900 thus enables a user to evaluate the historical alerts determined to be most similar to the current alert, via side-by-side visual comparisons of a selected one or more (or all) of the features for the alerts. In response to determining that a particular historical alert sufficiently matches the current alert, the user may assign the label of the particular historical alert to the current alert via actuating the selectable control 918. As a result, the failure mode, problem description, and cause of the historical alert may be applied to the current alert and can be used to determine a remedial action to perform responsive to the current alert.

The systems and methods illustrated herein may be described in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like.

The systems and methods of the present disclosure may be embodied as a customization of an existing system, an add-on product, a processing apparatus executing upgraded software, a standalone system, a distributed system, a method, a data processing system, a device for data processing, and/or a computer program product. Accordingly, any portion of the system or a module or a decision model may take the form of a processing apparatus executing code, an internet based (e.g., cloud computing) embodiment, an entirely hardware embodiment, or an embodiment combining aspects of the internet, software, and hardware. Furthermore, the system may take the form of a computer program product on a computer-readable storage medium or device having computer-readable program code (e.g., instructions) embodied or stored in the storage medium or device. Any suitable computer-readable storage medium or device may be utilized, including hard disks, CD-ROM, optical storage devices, magnetic storage devices, and/or other storage media. As used herein, a “computer-readable storage medium” or “computer-readable storage device” is not a signal.

Systems and methods may be described herein with reference to screen shots, block diagrams and flowchart illustrations of methods, apparatuses (e.g., systems), and computer media according to various aspects. It will be understood that each functional block of a block diagrams and flowchart illustration, and combinations of functional blocks in block diagrams and flowchart illustrations, respectively, can be implemented by computer program instructions.

Computer program instructions may be loaded onto a computer or other programmable data processing apparatus to produce a machine, such that the instructions that execute on the computer or other programmable data processing apparatus create means for implementing the functions specified in the flowchart block or blocks. These computer program instructions may also be stored in a computer-readable memory or device that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

In conjunction with the described devices and techniques, an apparatus for identifying successive alerts associated with a detected deviation from an operational state of a device is described.

The apparatus includes means for receiving feature data including time series data for multiple sensor devices associated with the device, the feature data corresponding to an alert indication. For example, the means for receiving the feature data may include the alert management device 102, the transceiver 118, the one or more processors 112, the alert generator 180, the feature importance analyzer 182, one or more devices or components configured to receive the feature data, or any combination thereof.

The apparatus includes means for determining, based on a first portion of the feature data, first feature importance data of a first alert associated with the first portion of the feature data. For example, the means for determining first feature importance data may include the alert management device 102, the one or more processors 112, the feature importance analyzer 182, the alert manager 184, one or more devices or components configured to determine the first feature importance data, or any combination thereof.

The apparatus includes means for determining, based on the first portion of the feature data, a first alert threshold corresponding to the first alert. For example, the means for determining the first alert threshold may include the alert management device 102, the one or more processors 112, the alert manager 184, one or more devices or components configured to determine the first alert threshold, or any combination thereof.

The apparatus includes means for determining, based on a second portion of the feature data, a metric corresponding to second feature importance data of the second portion, where the second portion is subsequent to the first portion in a time sequence of the feature data. For example, the means for determining the metric may include the alert management device 102, the one or more processors 112, the alert manager 184, one or more devices or components configured to determine the metric, or any combination thereof.

The apparatus also includes means for comparing the metric to the first alert threshold to determine whether the second portion corresponds to the first alert or to a second alert that is distinct from the first alert. For example, the means for comparing the metric to the first alert threshold may include the alert management device 102, the one or more processors 112, the alert manager 184, one or more devices or components configured to compare the metric to the first alert threshold to determine whether the second portion corresponds to the first alert or to a second alert that is distinct from the first alert, or any combination thereof.

Particular aspects of the disclosure are described below in the following clauses:

According to a Clause 1, a method of identifying successive alerts associated with a detected deviation from an operational state of a device includes: receiving, at a processor, feature data including time series data for multiple sensor devices associated with the device, the feature data corresponding to an alert indication; determining, at the processor and based on a first portion of the feature data, first feature importance data of a first alert associated with the first portion of the feature data; determining, at the processor and based on the first portion of the feature data, a first alert threshold corresponding to the first alert; determining, at the processor and based on a second portion of the feature data, a metric corresponding to second feature importance data of the second portion, wherein the second portion is subsequent to the first portion in a time sequence of the feature data; and comparing, at the processor, the metric to the first alert threshold to determine whether the second portion corresponds to the first alert or to a second alert that is distinct from the first alert.

Clause 2 includes the method of Clause 1, further including, in response to determining that the second portion corresponds to the second alert, generating a second alert threshold corresponding to the second alert.

Clause 3 includes the method of Clause 1 or Clause 2, further including generating an output indicating the first alert and the second alert.

Clause 4 includes the method of any of Clauses 1 to 3, further including displaying: a first diagnostic action or a first remedial action associated with the first alert; and a second diagnostic action or a second remedial action associated with the second alert.

Clause 5 includes the method of any of Clauses 1 to 4, further including selecting, based on the second alert, a control device to send a control signal to.

Clause 6 includes the method of Clause 1, further including, in response to determining that the second portion corresponds to the first alert, updating the first alert threshold based on the second feature importance data.

Clause 7 includes the method of Clause 1 or Clause 6, further including, in response to determining that the second portion corresponds to the first alert, updating the first feature importance data based on the second feature importance data.

Clause 8 includes the method of any of Clauses 1 to 7, wherein the first feature importance data includes values indicating relative importance of each of the sensor devices to the alert indication, and wherein the first alert threshold indicates a boundary of an expected range of values of feature importance data that are indicative of the first alert.

Clause 9 includes the method of any of Clauses 1 to 8, wherein the first alert threshold indicates an amount of difference from the first feature importance data.

Clause 10 includes the method of any of Clauses 1 to 9, wherein the metric indicates a similarity between values of the first feature importance data and values of the second feature importance data.

Clause 11 includes the method of any of Clauses 1 to 10, further including generating a graphical user interface including: a graph indicative of a performance metric of the device over time; a graphical indication of the first alert corresponding to a portion of the graph; and an indication of one or more sets of the feature data associated with the first alert.

According to a Clause 12, a system to identify successive alerts associated with a detected deviation from an operational state of a device includes: a memory configured to store instructions; and one or more processors coupled to the memory, the one or more processors configured to execute the instructions to: receive feature data including time series data for multiple sensor devices associated with the device, the feature data corresponding to an alert indication; determine, based on a first portion of the feature data, first feature importance data of a first alert associated with the first portion of the feature data; determine, based on the first portion of the feature data, a first alert threshold corresponding to the first alert; determine, based on a second portion of the feature data, a metric corresponding to second feature importance data of the second portion, wherein the second portion is subsequent to the first portion in a time sequence of the feature data; and determine, based on a comparison of the metric to the first alert threshold, whether the second portion corresponds to the first alert or to a second alert that is distinct from the first alert.

Clause 13 includes the system of Clause 12, wherein the one or more processors are configured, in response to determining that the second portion corresponds to the second alert, to generate a second alert threshold corresponding to the second alert.

Clause 14 includes the system of Clause 12 or Clause 13, wherein the one or more processors are configured, in response to determining that the second portion corresponds to the second alert, to generate an output indicating the first alert and the second alert.

Clause 15 includes the system of any of Clauses 12 to 14, wherein the one or more processors are configured, in response to determining that the second portion corresponds to the second alert, to generate an output indicating: a first diagnostic action or a first remedial action associated with the first alert; and a second diagnostic action or a second remedial action associated with the second alert.

Clause 16 includes the system of Clause 12, wherein the one or more processors are configured, in response to determining that the second portion corresponds to the first alert, to update the first alert threshold based on the second feature importance data.

Clause 17 includes the system of Clause 12 or Clause 16, wherein the one or more processors are configured, in response to determining that the second portion corresponds to the first alert, to update the first feature importance data based on the second feature importance data.

Clause 18 includes the system of any of Clauses 12 to 17, further including a display interface coupled to the one or more processors and configured to provide a graphical user interface to a display device, wherein the graphical user interface includes a label, an indication of a diagnostic action, an indication of a remedial action, or a combination thereof, associated with each of the identified successive alerts.

Clause 19 includes the system of any of Clauses 12 to 18, wherein the first feature importance data includes values indicating relative importance of each of the sensor devices to the alert indication, and wherein the first alert threshold indicates a boundary of an expected range of values of feature importance data that are indicative of the first alert.

Clause 20 includes the system of any of Clauses 12 to 19, wherein the first alert threshold indicates a difference from the first feature importance data.

Clause 21 includes the system of any of Clauses 12 to 20, wherein the metric indicates a similarity between values of the first feature importance data and values of the second feature importance data.

Clause 22 includes the system of any of Clauses 12 to 21, wherein the one or more processors are configured, in response to determining that the second portion corresponds to the first alert, to generate a graphical user interface including: a graph indicative of a performance metric of the device over time; a graphical indication of the first alert corresponding to a portion of the graph; and an indication of one or more sets of the feature data associated with the first alert.

According to a Clause 23, a computer-readable storage device stores instructions that, when executed by one or more processors, cause the one or more processors to: receive feature data including time series data for multiple sensor devices associated with a device, the feature data corresponding to an alert indication; determine, based on a first portion of the feature data, first feature importance data of a first alert associated with the first portion of the feature data; determine, based on the first portion of the feature data, a first alert threshold corresponding to the first alert; determine, based on a second portion of the feature data, a metric corresponding to second feature importance data of the second portion, wherein the second portion is subsequent to the first portion in a time sequence of the feature data; and determine, based on a comparison of the metric to the first alert threshold, whether the second portion corresponds to the first alert or to a second alert that is distinct from the first alert.

Clause 24 includes the computer-readable storage device of Clause 23, wherein the instructions, when executed by the one or more processors, further cause the one or more processors, in response to determining that the second portion corresponds to the second alert, to: generate a second alert associated with the second portion; and generate a second alert threshold corresponding to the second alert.

Clause 25 includes the computer-readable storage device of Clause 23 or Clause 24, wherein the instructions, when executed by the one or more processors, further cause the one or more processors, in response to determining that the second portion corresponds to the second alert, to generate an output indicating the first alert and the second alert.

Clause 26 includes the computer-readable storage device of any of Clauses 23 to 25, wherein the instructions, when executed by the one or more processors, further cause the one or more processors, in response to determining that the second portion corresponds to the second alert, to generate an output indicating: a first diagnostic action or a first remedial action associated with the first alert; and a second diagnostic action or a second remedial action associated with the second alert.

Clause 27 includes the computer-readable storage device of Clause 23, wherein the instructions, when executed by the one or more processors, further cause the one or more processors, in response to determining that the second portion corresponds to the first alert, to update the first alert threshold based on the second feature importance data.

Clause 28 includes the computer-readable storage device of Clause 23 or Clause 27, wherein the instructions, when executed by the one or more processors, further cause the one or more processors, in response to determining that the second portion corresponds to the first alert, to update the first feature importance data based on the second feature importance data.

Clause 29 includes the computer-readable storage device of any of Clauses 23 to 28, wherein the first feature importance data includes values indicating relative importance of each of the sensor devices to the alert indication, and wherein the first alert threshold indicates a boundary of an expected range of values of feature importance data that are indicative of the first alert.

Clause 30 includes the computer-readable storage device of any of Clauses 23 to 29, wherein the first alert threshold indicates a difference from the first feature importance data.

Clause 31 includes the computer-readable storage device of any of Clauses 23 to 30, wherein the metric indicates a similarity between values of the first feature importance data and values of the second feature importance data.

Clause 32 includes the computer-readable storage device of any of Clauses 23 to 31, wherein the instructions, when executed by the one or more processors, further cause the one or more processors, in response to determining that the second portion corresponds to the first alert, to generate a graphical user interface including: a graph indicative of a performance metric of the device over time; a graphical indication of the first alert corresponding to a portion of the graph; and an indication of one or more sets of the feature data associated with the first alert.

Although the disclosure may include one or more methods, it is contemplated that it may be embodied as computer program instructions on a tangible computer-readable medium, such as a magnetic or optical memory or a magnetic or optical disk/disc. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Changes and modifications may be made to the disclosed embodiments without departing from the scope of the present disclosure. These and other changes or modifications are intended to be included within the scope of the present disclosure, as expressed in the following claims.

What is claimed is:

1. A method of identifying successive alerts associated with a detected deviation from an operational state of a device, the method comprising:
receiving, at a processor, feature data including time series data for multiple sensor devices associated with the device, the feature data corresponding to an alert indication;
determining, at the processor and based on a first portion of the feature data, first feature importance data of a first alert associated with the first portion of the feature data;
determining, at the processor and based on the first portion of the feature data, a first alert threshold corresponding to the first alert;
determining, at the processor and based on a second portion of the feature data, a metric corresponding to second feature importance data of the second portion, wherein the second portion is subsequent to the first portion in a time sequence of the feature data; and
comparing, at the processor, the metric to the first alert threshold to determine whether the second portion corresponds to the first alert or to a second alert that is distinct from the first alert.

2. The method of claim 1, further comprising, in response to determining that the second portion corresponds to the second alert, generating a second alert threshold corresponding to the second alert.

3. The method of claim 2, further comprising generating an output indicating the first alert and the second alert.

4. The method of claim 3, further comprising displaying:
a first diagnostic action or a first remedial action associated with the first alert; and
a second diagnostic action or a second remedial action associated with the second alert.

5. The method of claim 2, further comprising selecting, based on the second alert, a control device to send a control signal to.

6. The method of claim 1, further comprising, in response to determining that the second portion corresponds to the first alert, updating the first alert threshold based on the second feature importance data.

7. The method of claim 1, further comprising, in response to determining that the second portion corresponds to the first alert, updating the first feature importance data based on the second feature importance data.

8. The method of claim 1, wherein the first feature importance data includes values indicating relative importance of each of the sensor devices to the alert indication, and wherein the first alert threshold indicates a boundary of an expected range of values of feature importance data that are indicative of the first alert.

9. The method of claim 1, wherein the first alert threshold indicates an amount of difference from the first feature importance data.

10. The method of claim 1, wherein the metric indicates a similarity between values of the first feature importance data and values of the second feature importance data.

11. The method of claim 1, further comprising generating a graphical user interface including:
a graph indicative of a performance metric of the device over time;
a graphical indication of the first alert corresponding to a portion of the graph; and
an indication of one or more sets of the feature data associated with the first alert.

12. A system to identify successive alerts associated with a detected deviation from an operational state of a device, the system comprising:
a memory configured to store instructions; and
one or more processors coupled to the memory, the one or more processors configured to execute the instructions to:
receive feature data including time series data for multiple sensor devices associated with the device, the feature data corresponding to an alert indication;
determine, based on a first portion of the feature data, first feature importance data of a first alert associated with the first portion of the feature data;
determine, based on the first portion of the feature data, a first alert threshold corresponding to the first alert;
determine, based on a second portion of the feature data, a metric corresponding to second feature importance data of the second portion, wherein the second portion is subsequent to the first portion in a time sequence of the feature data; and
determine, based on a comparison of the metric to the first alert threshold, whether the second portion corresponds to the first alert or to a second alert that is distinct from the first alert.

13. The system of claim 12, further comprising a display interface coupled to the one or more processors and configured to provide a graphical user interface to a display device, wherein the graphical user interface includes a label, an indication of a diagnostic action, an indication of a remedial action, or a combination thereof, associated with each of the identified successive alerts.

14. The system of claim 12, wherein the one or more processors are configured, in response to determining that the second portion corresponds to the second alert, to generate a second alert threshold corresponding to the second alert.

15. The system of claim 12, wherein the one or more processors are configured, in response to determining that the second portion corresponds to the first alert, to update the first alert threshold based on the second feature importance data.

16. The system of claim 12, wherein the one or more processors are configured, in response to determining that the second portion corresponds to the first alert, to update the first feature importance data based on the second feature importance data.

17. The system of claim 12, wherein the first feature importance data includes values indicating relative importance of each of the sensor devices to the alert indication, and wherein the first alert threshold indicates a boundary of an expected range of values of feature importance data that are indicative of the first alert.

18. The system of claim 12, wherein the first alert threshold indicates a difference from the first feature importance data.

19. The system of claim 12, wherein the metric indicates a similarity between values of the first feature importance data and values of the second feature importance data.

20. A computer-readable storage device storing instructions that, when executed by one or more processors, cause the one or more processors to:
receive feature data including time series data for multiple sensor devices associated with a device, the feature data corresponding to an alert indication;
determine, based on a first portion of the feature data, first feature importance data of a first alert associated with the first portion of the feature data;
determine, based on the first portion of the feature data, a first alert threshold corresponding to the first alert;
determine, based on a second portion of the feature data, a metric corresponding to second feature importance data of the second portion, wherein the second portion is subsequent to the first portion in a time sequence of the feature data; and
determine, based on a comparison of the metric to the first alert threshold, whether the second portion corresponds to the first alert or to a second alert that is distinct from the first alert.
